(19) United States
(12) Patent Application Publication
(10) Pub. No.: US 2026/0003235 A1
(43) Pub. Date: Jan. 1, 2026

(54) DISPLAY DEVICE

(71) Applicant: SAMSUNG ELECTRONICS CO., LTD., Suwon-si (KR)

(72) Inventors: Hyojae JANG, Suwon-si (KR); Sungho KIM, Suwon-si (KR); Eunseo JANG, Suwon-si (KR)

(73) Assignee: SAMSUNG ELECTRONICS CO., LTD., Suwon-si (KR)

(21) Appl. No.: 19/205,286

(22) Filed: May 12, 2025

Related U.S. Application Data
(63) Continuation of application No. PCT/KR2025/005638, filed on Apr. 25, 2025.

(30) Foreign Application Priority Data
Jun. 28, 2024 (KR) 10-2024-0085812

(51) Int. Cl. G02F 1/1343

(52) U.S. Cl. CPC G02F 1/134327; G02F 1/134345

(57) ABSTRACT

Disclosed herein is a display device including a sub pixel electrode having, in each do main, at least one pixel slit of which a width on a center line of the sub pixel electrode is greater than a width on an outer line of the sub pixel electrode, for each domain, and a common electrode having, in each domain, at least one common slit of which a width on a center line of the common electrode is greater than a width on an outer line of the common electrode, wherein the at least one pixel slit is misaligned with the at least one common slit between the sub pixel electrode and the common electrode.

### CROSS-REFERENCE TO RELATED APPLICATIONS

This application is a continuation application of International Application No. PCT/KR2025/005638, filed on Apr. 25, 2025, which is based on and claims priority from Korean Patent Application No. 10-2024-0085812, filed on Jun. 28, 2024, the disclosures of which are herein incorporated by reference in their entireties.

### BACKGROUND

### 1. Field

One or more example embodiments of the disclosure relate to a display device for improving a viewing angle.

### 2. Description of Related Art

Display devices are devices for displaying visual and three-dimensional image information and include, for example, liquid crystal display devices (LCDs), electro-luminescence display devices (ELDs), field emission display devices (FEDs), plasma display panels (hereinafter referred to as “PDPs”), thin film liquid crystal displays (TFT-LCDs), flexible display devices, etc.

The liquid crystal display device is widely used among flat panel display devices and includes two substrates with electrodes and liquid crystals provided between the two substrates inside two glass plates attached with a sealant. The liquid crystal display device displays images by applying a voltage to the electrodes of the two substrates to generate an electric field and setting an alignment of liquid crystal molecules through the electric field to control polarization of incident light.

The liquid crystal display devices include a vertical alignment (VA) mode liquid crystal display device in which a long axes of liquid crystal molecules are vertically aligned between two substrates when no electric field is applied.

The VA mode liquid crystal display device implements a wide viewing angle by including multiple domains with different alignment directions of liquid crystals in one pixel.

Because related art VA mode liquid crystal display devices implement one pixel through multiple domains, the related art VA mode liquid crystal display devices have problems of a reduced opening ratio due to wires connected to the multiple domains, and reduced transmittance and loss of brightness due to the reduced opening ratio.

The related art VA mode liquid crystal display devices have problems of wash-out, brightness reduction, and image quality deterioration when a rotation direction of liquid crystals within the multiple domains deviates from a preset range.

### SUMMARY

An aspect of the disclosure provides a display device that may include a sub pixel electrode having at least one pixel slit of which a width on a center line of the sub pixel electrode is greater than a width on an outer line of the sub pixel electrode.

Another aspect of the disclosure provides a display device that may include a sub pixel electrode having at least one pixel slit of which a width on a center line of the sub pixel electrode is greater than a width on an outer line of the sub pixel electrode in each domain, and a common electrode having at least one common slit of which a width on a center line of the common electrode is greater than a width on an outer line of the common electrode in each domain, wherein the at least one pixel slit of the sub pixel electrode is misaligned with the at least one common slit of the common electrode.

A display device according to an aspect may include a common electrode, a split pixel electrode spaced from the common electrode and divided into a plurality of domains, and a liquid crystal portion provided between the common electrode and a sub pixel electrode. The sub pixel electrode of the display device according to an aspect may include, in each domain of the plurality of domains, at least one pixel slit of which a width on a center line of the sub pixel electrode is greater than a width on an outer line of the sub pixel electrode. Adjacent ones of the plurality of domains of the display device according to an aspect may have symmetrical arrangements of the at least one pixel slit.

The sub pixel electrode of the display device according to an aspect may be, in each domain, divided into a plurality of split pixel electrodes by the at least one pixel slit. The adjacent ones of the plurality of domains of the display device according to an aspect may have symmetrical arrangements of the plurality of split pixel electrodes.

In each domain, a width of a first side of each of the plurality of split pixel electrodes of the display device according to an aspect, the first side being adjacent to the center line of the sub pixel electrode, may be smaller than a width of a second side of each of the plurality of split pixel electrodes, the second side being adjacent to the outer line of the split pixel electrode.

In each domain of the display device according to an aspect, a reference slope of the at least one pixel slit may be the same as a slope of a center line of each of the plurality of split pixel electrodes. The center line of each of the plurality of split pixel electrodes of the display device according to an aspect may be a line connecting a center of the first side of the split pixel electrode to a center of the second side of the split pixel electrode.

The reference slope of the at least one pixel slit of the display device according to an aspect may be a slope of a center line of the at least one pixel slit. The center line of the at least one pixel slit of the display device according to an aspect may be a line connecting a center of a width of the at least one pixel slit on the center line of the sub pixel electrode to a center of a width of the at least one pixel slit on the outer line of the sub pixel electrode. Each of the plurality of split pixel electrodes of the display device according to an aspect may be spaced a preset distance from a position of the center line of the at least one pixel slit.

First distances between first sides of the plurality of split pixel electrodes of the display device according to an aspect may be the same. Second distances between second sides of the plurality of split pixel electrodes of the display device according to an aspect may be the same. In the display device according to an aspect, the first distances may be greater than the second distances.

In each domain of the display device according to an aspect, a strength of an electric field formed between the plurality of split pixel electrodes and the common electrode may increase toward the second side of each split pixel electrode from the first side of the split pixel electrode.

The common electrode of the display device according to an aspect may be divided into the plurality of domains, and, in each domain, the common electrode may include at least one common slit of which a width on a center line of the common electrode is greater than a width on an outer line of the common electrode. Adjacent ones of the plurality of domains of the display device according to an aspect may have symmetrical arrangements of the at least one common slit.

The common electrode of the display device according to an aspect may be, in each domain, divided into a plurality of split common electrodes by the at least one common slit. The adjacent ones of the plurality of domains of the display device according to an aspect may have symmetrical arrangements of the plurality of split common electrodes.

In each domain, a width of a first side of each of the plurality of split common electrodes of the display device according to an aspect, the first side being adjacent to the center line of the common electrode, may be smaller than a width of a second side of each of the plurality of split common electrodes, the second side being adjacent to the outer line of the common electrode.

In each domain of the display device according to an aspect, a reference slope of the at least one common slit may be the same as a slope of a center line of each of the plurality of split common electrodes. The center line of each of the plurality of split common electrodes of the display device according to an aspect may be a line connecting a center of the first side of the split common electrode to a center of the second side of the split common electrode.

A reference slope of the at least one common slit of the display device according to an aspect may be a slope of a center line of the at least one common slit. A center line of the at least one common slit of the display device according to an aspect may be a line connecting a center of a width of the at least one common slit on the center line of the common electrode to a center of a width of the at least one common slit on the outer line of the common electrode.

The plurality of split common electrodes of the display device according to an aspect may be spaced a preset distance from a position of the center line of the at least one common slit.

First distances between first sides of the plurality of split common electrodes of the display device according to an aspect may be the same. Second distances between second sides of the plurality of split common electrodes of the display device according to an aspect may be the same. In the display device according to an aspect, the first distances may be greater than the second distances.

A position of the at least one common slit of the display device according to an aspect may correspond to a surface area of at least one split pixel electrode among the plurality of split pixel electrodes.

A position of the at least one pixel slit of the display device according to an aspect may correspond to a surface area of at least one split common electrode among the plurality of split common electrodes.

A distance between the plurality of split common electrodes of the display device according to an aspect may decrease toward the outer line of the common electrode from the center line of the common electrode. A distance between the plurality of split pixel electrodes of the display device according to an aspect may decrease toward the outer line of the sub pixel electrode from the center line of the sub pixel electrode.

In the display device according to an aspect, an area of the plurality of split pixel electrodes facing the plurality of split common electrodes may increase toward the outer line of the sub pixel electrode from the center line of the sub pixel electrode.

In the display device according to an aspect, a strength of an electric field formed between the plurality of split pixel electrodes and the plurality of split common electrodes may increase toward the outer line of the sub pixel electrode from the center line of the sub pixel electrode.

The disclosure may arrange split pixel electrodes split by at least one pixel slit at different distances, thereby aligning liquid crystals at various rotation angles. That is, the disclosure may align the liquid crystals at rotation angles corresponding to 8 domains or more, with four domains.

The disclosure may obtain rotation angles of liquid crystals in a form of gradation in the same direction while maintaining transmittance corresponding to four domains, thereby providing uniform viewing angles in various directions compared to existing four domains and improving image display quality of a display device.

Accordingly, quality and marketability of a display device may be improved, a user's satisfaction may be raised, and performance of the display device may be improved.

### BRIEF DESCRIPTION OF DRAWINGS

Example embodiments of the disclosure will be more clearly understood from the following detailed description taken in conjunction with the accompanying drawings.

FIG. 1 shows an appearance of a display device according to an embodiment.

FIG. 2 is an exploded perspective view of a display device including a direct-type backlight unit according to an embodiment.

FIG. 3 is an exploded perspective view of a display device including an edge-type backlight unit according to an embodiment.

FIG. 4 is a detailed configuration diagram of a display panel provided in a display device according to an embodiment.

FIG. 5 is an example diagram of a pixel electrode provided in a display panel of a display device according to an embodiment.

FIG. 6 is an example diagram of a sub pixel electrode provided in a display panel of a display device according to an embodiment.

FIGS. 7 and 8 are example diagrams of a sub pixel electrode of a first domain provided in a display panel of a display device according to an embodiment.

FIG. 9 is an example diagram of a split pixel electrode provided in a display panel of a display device according to an embodiment.

FIG. 10 is an example arrangement diagram of split pixel electrodes of a first domain provided in a display panel of a display device according to an embodiment.

FIGS. 11 and 12 are example diagrams of electric fields between common electrodes and sub pixel electrodes provided in a display panel of a display device according to an embodiment.

FIG. 13 is an example diagram of a light output of a sub pixel provided in a display panel of a display device according to an embodiment.

FIGS. 14 and 15 are example diagrams of liquid crystal alignments between common electrodes and sub pixel electrodes provided in a display panel of a display device according to an embodiment.

FIG. 16 shows an example diagram of a liquid crystal alignment taken along line X1-X2 of FIG. 13.

FIG. 17 is a detailed configuration diagram of a display panel provided in a display device according to another embodiment.

FIGS. 18 and 19 are example diagrams of a common electrode of a first electrode portion provided in a display panel of a display device according to another embodiment.

FIG. 20 is an example diagram of a common electrode of a first domain provided in a display panel of a display device according to another embodiment.

FIGS. 21 and 22 are example diagrams of a sub pixel electrode provided in a display panel of a display device according to another embodiment.

FIG. 23 is an example diagram of a sub pixel electrode of a first domain provided in a display panel of a display device according to another embodiment.

FIGS. 24 and 25 are example arrangement diagrams of common electrodes and sub pixel electrodes provided in a display panel of a display device according to another embodiment.

FIGS. 26 and 27 are example diagrams of electrical fields between common electrodes and sub pixel electrodes provided in a display panel of a display device according to another embodiment.

FIG. 28 is an example view of a light output of a sub pixel provided in a display panel of a display device according to another embodiment.

FIGS. 29 and 30 are example diagrams of liquid crystal alignments between common electrodes and sub pixel electrodes provided in a display panel of a display device according to another embodiment.

FIG. 31 is an example diagram of a liquid crystal alignment taken along line X1-X2 of FIG. 28.

### DETAILED DESCRIPTION

Various embodiments of the present disclosure and terms used therein are not intended to limit the technical features described in the disclosure to specific embodiments, and should be understood to include various modifications, equivalents, or substitutes of the corresponding embodiments.

In connection with the description of the drawings, similar reference numerals may be used for similar or related components.

The singular form of a noun corresponding to an item may include one or a plurality of the items unless clearly indicated otherwise in a related context.

In the specification, phrases, such as “A or B”, “at least one of A and B”, “at least one of A or B,” “A, B or C,” “at least one of A, B and C,” and “at least one of A, B, or C”, may include any one or all possible combinations of items listed together in the corresponding phrase among the phrases.

As used herein, the term “and/or” includes any and all combinations of one or more of associated listed items.

Terms such as “1^{st}”, “2^{nd}”, or “first” or “second” may be used simply to distinguish a component from other components, without limiting the component in other aspects (e.g., importance or order).

A certain (e.g., a first) component is referred to as “coupled” or “connected” with or without the terms “functionally” or “communicatively” to another (e.g., second) component. When mentioned, it means that the certain component can be connected to the other component directly (e.g., by wire), wirelessly, or via a third component.

It will be understood that when the terms “includes,” “comprises,” “including,” and/or “comprising,” when used in this specification, specify the presence of stated features, figures, steps, operations, components, members, or combinations thereof, but do not preclude the presence or addition of one or more other features, figures, steps, operations, components, members, or combinations thereof.

It will be understood that when a certain component is referred to as being “connected to”, “coupled to”, “supported by” or “in contact with” another component, it can be directly or indirectly connected to, coupled to, supported by, or in contact with the other component. When a component is indirectly connected to, coupled to, supported by, or in contact with another component, it may be connected to, coupled to, supported by, or in contact with the other component through a third component.

It will also be understood that when a component is referred to as being “on” or “over” another component, it can be directly on the other component or intervening components may also be present.

Hereinafter, the disclosure will be described in detail with reference to the accompanying drawings.

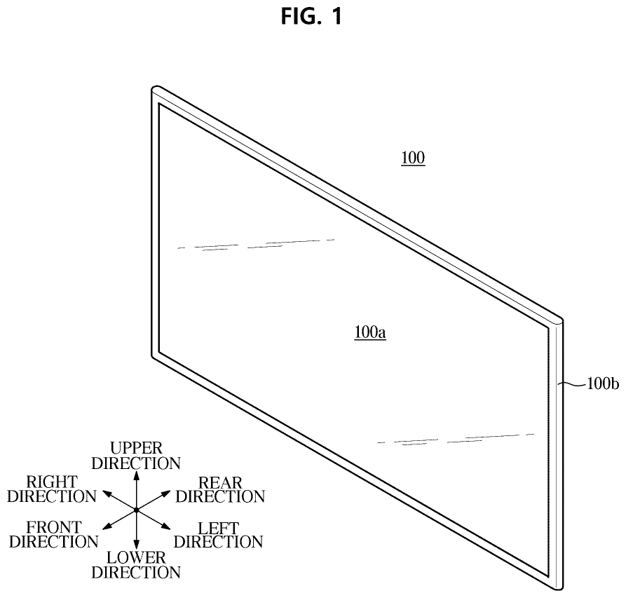

FIG. 1 shows an appearance of a display device according to an embodiment.

A display device 100 may be an apparatus that displays an image received from an external device or a stored image.

The display device 100 may include, according to a function, a television, a billboard, a guide sign, a display of a terminal (for example, a smart phone, a tablet, and a laptop), or a display of various electric devices.

The display device 100 may include a main body 100a forming an appearance of the display device 100.

The display device 100 may further include a bezel 100b positioned at edges of the main body 100a. The display device 100 may be protected from an external force due to the bezel 100b.

The display device 100 may be implemented as a bezel-less type.

The display device 100 may further include a stand (not shown) provided in a lower portion of the main body 100a to support the main body 100a, in correspondence to an installation environment and function, or may further include a bracket (not shown) provided on a rear surface of the main body 100a to mount the main body 100a on a wall, etc.

The display device 100 may be a liquid crystal display that displays an image by using light from a backlight unit.

The backlight unit of the display device 100 may be classified into a direct-type backlight unit and an edge-type backlight unit according to an arrangement position of the backlight unit.

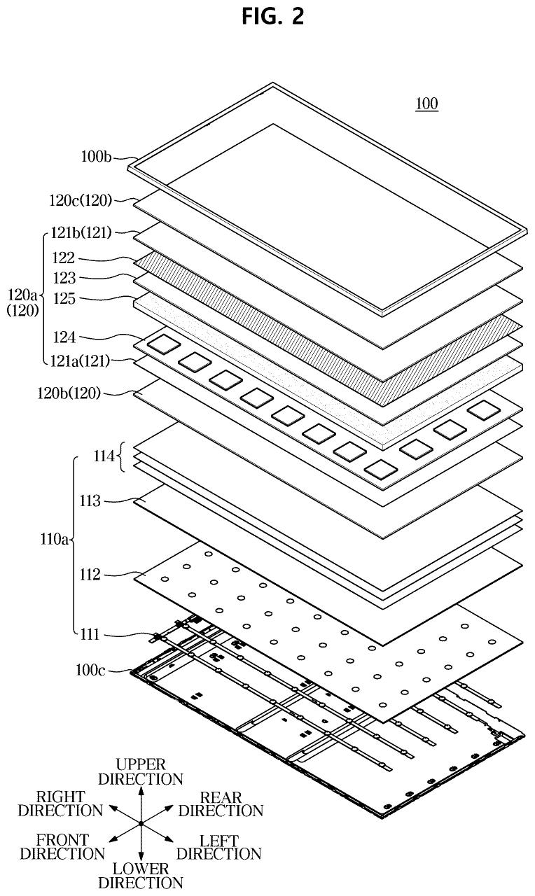

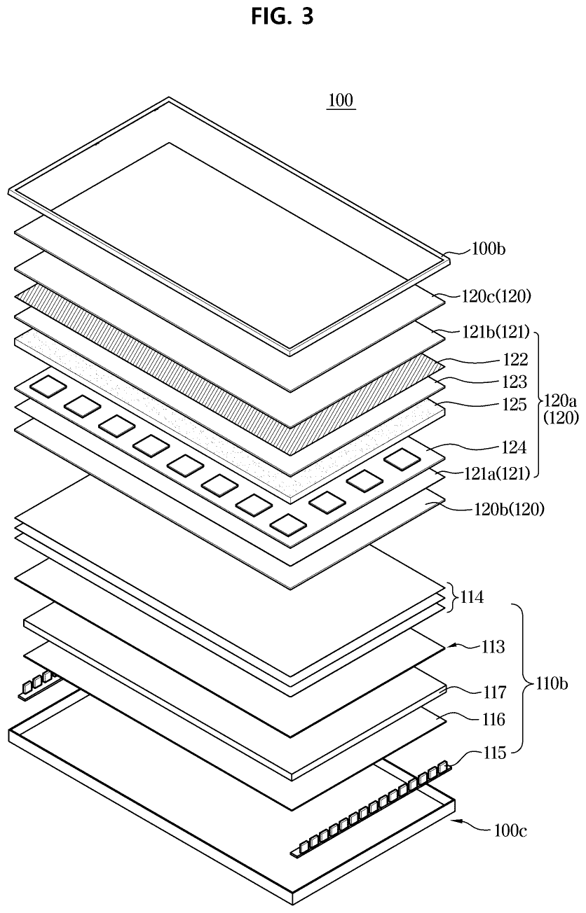

A structure of the display device 100 will be described with reference to FIGS. 2 and 3.

FIG. 2 is a configuration diagram of a display device including a direct-type backlight unit according to an embodiment.

Hereinafter, for convenience of description, a direction in which an image is displayed on the display device 100 is referred to as a front direction, and an opposite direction of the front direction of the display device 100 is referred to as a rear direction.

As shown in FIG. 2, the display device 100 may further include a case 100c positioned behind the main body 100a, coupled to the bezel 100b, and forming a rear appearance of the display device 100.

The display device 100 may include a backlight unit 110a and a display panel 120 positioned between the bezel 100b and the case 100c.

The display device 100 may further include a touch panel (not shown) positioned in front of the display panel 120.

The backlight unit 110a may be positioned between the display panel 120 and the case 100c in such a way as to be spaced a preset distance from the display panel 120, and emit light toward the display panel 120.

The backlight unit 110a may include a light-emitting portion 111, a reflective panel 112, a diffuser panel 113, and an optical sheet 114.

The light-emitting portion 111 may be positioned adjacent to the case 100c and emit light toward the display panel 120. The light-emitting portion 111 may be positioned between the case 100c and the reflective panel 112.

The light-emitting portion 111 may include any kind of a light source, for example, among a lamp, such as a cold cathode fluorescence lamp (CCFL) and an external electrode fluorescence lamp, or a light emitting diode.

The reflective panel 112 may be positioned between the light-emitting portion 111 and the case 100c.

Also, the reflective panel 112 may be positioned on the same plane as the light-emitting portion 111.

The reflective panel 112 may include a plurality of through holes in which a plurality of light sources of the light-emitting portion 111 are inserted. That is, because the plurality of light sources of the light-emitting portion 111 are inserted and arranged in the through holes of the reflective panel 112, the plurality of light sources may be exposed to outside.

When a part of light emitted from the light-emitting portion 111 is incident to the reflective panel 112, the reflective panel 112 may reflect the incident light toward the display panel 120. The part of light emitted from the light-emitting portion 111 may be light emitted toward the case 100c, not toward the display panel 120, and/or light reflected from the diffuser panel 113.

The reflective panel 112 may be manufactured using a synthetic resin, such as polycarbonate (PC) or polyethylene terephthalate (PET), or may be manufactured using one or more of various metal materials.

The diffusion panel 113 may be a semitransparent panel that is positioned between the display panel 120 and the light-emitting portion 111 of the backlight unit 110a and diffuses light emitted from the light-emitting portion 111 along a surface to make colors and brightness of an entire screen of the display panel 120 appear uniform, thereby improving brightness of light emitted from the light emitting portion 111.

The backlight unit 110a may further include one or at least two optical sheets 114.

The optical sheet 114 may improve optical characteristics by using a method such as uniformizing brightness of incident light and concentrating diffused light and/or light with high brightness.

An optical sheet among the at least two optical sheets 114 may selectively transmit light according to a wavelength of the light and reflect light having a different wavelength from the selected light toward the backlight unit 110a, thereby increasing light transmission efficiency. The optical sheet may include a prism sheet in which prisms are formed.

Another optical sheet among the at least two optical sheets 114 may polarize light because the optical sheet does not allow light other than light having a specific wavelength to be transmitted.

The optical sheet may include a reflective polarizing sheet (e.g., Dual Brightness Enhancement Film (DBEF)) by birefringent multilayer coating.

The display panel 120 may be positioned inside the case 100c and convert electrical information into image information by using a change in liquid crystal transmittance according to an applied voltage, and the display panel 120 may include a liquid crystal panel 120a, a first polarizing panel 120b, and a second polarizing panel 120c.

The liquid crystal panel 120a may include liquid crystals and control transmittance of light by changing an alignment of the liquid crystals, thereby forming a color of each pixel.

By a combination of colors of pixels formed on the liquid crystal panel 120a, an image may be implemented on the display device 100.

The liquid crystal panel 120a may include a substrate portion 121, a color filter portion 122, a first electrode portion 123, a second electrode portion 124, and a liquid crystal portion 125.

The substrate portion 121 may include a first substrate 121a and a second substrate 121b attached to each other by a sealant.

The color filter portion 122, the first electrode portion 123, the second electrode portion 124, and the liquid crystal portion 125 may be provided between the first and second substrates 121a and 121b.

The first and second substrates 121a and 121b may be glass substrates.

The first substrate 121a, the second electrode portion 124, the liquid crystal portion 125, the first electrode portion 123, the color filter portion 122, and the second substrate 121b may be stacked sequentially in this order. However, the stacking order is not limited to that shown in FIG. 2.

A configuration of the liquid crystal panel 120a will be described in detail, below.

The first polarizing panel 120b may be positioned between the backlight unit 110a and the liquid crystal panel 120a, and while non-polarized light emitted from the backlight unit 110a is incident to the first polarizing panel 120b, the first polarizing panel 120b may pass only light having a first polarization axis among the incident light. The light passed through the first polarizing panel 120b may be incident to the liquid crystal panel 120a.

The second polarizing panel 120c may face the first polarizing panel 120b with the liquid crystal panel 120a being interposed therebetween and have a second polarizing axis that is perpendicular to a first polarizing axis of the first polarizing panel 120b. That is, the second polarizing panel 120c may be positioned on one surface of the liquid crystal panel 120a and polarize image light output from the liquid crystal panel 120a in one direction.

The display device 100 may further include a first support member (not shown) positioned between the diffuser panel 113 and the light-emitting portion 111, maintaining a gap between the diffuser panel 113 and the light-emitting portion 111, and fixing the diffuser panel 113, and a second support member (not shown) positioned between the first polarizing panel 120b and the optical sheet 114, maintaining a gap between the first polarizing panel 120b and the optical sheet 114, and fixing the diffuser panel 113, the optical sheet 114, and the display panel 120.

FIG. 3 is a configuration diagram of a display device including an edge-type backlight unit according to an embodiment.

As shown in FIG. 3, the display device 100 may further include the case 100c coupled to a bezel 100b, positioned in a rear side of the display device 100, and forming the rear appearance of the display device 100.

The display device 100 may include the display panel 120 and a backlight unit 110b positioned between the bezel 100b and the case 100c.

Also, the display device 100 may further include a touch panel (not shown) positioned in front of the display panel 120.

The backlight unit 110b may be positioned between the display panel 120 and the case 100c, spaced a preset distance from the display panel 120, and emit light toward the display panel 120.

The backlight unit 110b may include a light-emitting portion 115, a reflective panel 116, a light guide panel 117, a diffuser panel 113, and an optical sheet 114.

The light-emitting portion 115 may be positioned respectively at both sides of the case 100c in such a way as to be adjacent to the case 100c, and emit light toward the light guide panel 117.

The reflective panel 116 may be positioned between the light-emitting portions 115 behind the light guide panel 117 and emit a part of light emitted from the light-emitting portions 115 toward the light guide panel 117.

The light guide panel 117 may be positioned between the light-emitting portions 115 in such a way as to be adjacent to the reflective panel 116, and, when light emitted from the light-emitting portions 115 is incident to the light guide panel 117, the light guide panel 117 may guide the incident light toward the display panel 120.

The light guide panel 117 may be in a form of a plate including polycarbonate (PC) or a plastic material such as polymethylmethacrylate (PMMA), which is an acrylic transparent resin as one of transparent materials capable of transmitting light.

The light guide panel 117 may induce diffusion of light while transmitting light, due to excellent transparency, weather resistance, and coloring properties.

The diffusion panel 113 may be a translucent panel that is positioned between the display panel 120 and the light guide panel 117 of the backlight unit 110b and may diffuse light emitted from the light guide panel 117 along a surface to make colors and brightness of an entire screen of the display panel 120 appear uniform, thereby improving brightness of light emitted from the light emitting portions 115.

The backlight unit 110b may further include one or at least two optical sheets 114.

The optical sheet 114 may improve optical characteristics by using a method such as uniformizing brightness of incident light and concentrating diffused light and/or light with high brightness.

An optical sheet among the optical sheets 114 may selectively transmit light according to a wavelength of the light and reflect light having a different wavelength from the selected light toward the backlight unit 110b, thereby increasing light transmission efficiency. The optical sheet may include a prism sheet in which prisms are formed.

Another optical sheet may polarize light because the optical sheet does not allow light other than light having a specific wavelength to be transmitted.

The display panel 120 may be positioned inside the case 100c and convert electrical information into image information by using a change in liquid crystal transmittance according to an applied voltage, and the display panel 120 may include the liquid crystal panel 120a, the first polarizing panel 120b, and the second polarizing panel 120c.

The liquid crystal panel 120a, the first polarizing panel 120b, and the second polarizing panel 120c of the display panel 120 of the display device 100 provided with an edge-type backlight unit may have the same configuration as the liquid-crystal panel 120a, the first polarizing panel 120b, and the second polarizing panel 120c of the display panel 120 of the display device 100 provided with a direct-type backlight unit, and therefore, descriptions thereof will be omitted.

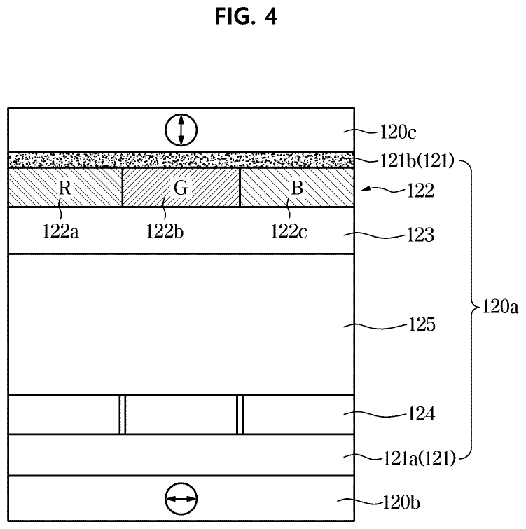

FIG. 4 is a detailed configuration diagram of a display panel provided in a display device according to an embodiment.

The display panel 120 may include the liquid crystal panel 120a, the first polarizing panel 120b provided on one side of the liquid crystal panel 120a, and the second polarizing panel 120c provided on another side of the liquid crystal panel 120a.

The liquid crystal panel 120a may include the substrate portion 121, the color filter portion 122, the first electrode portion 123, the second electrode portion 124, and the liquid crystal portion 125, which are stacked on each other.

The first substrate 121a of the substrate portion 121 may be positioned adjacent to the first polarizing panel 120b.

The first and second substrates 121a and 121b of the substrate portion 121 may support the first electrode portion 123, the second electrode portion 124, and the liquid crystal portion 125 to maintain positions and states of the first electrode portion 123, the second electrode portion 124, and the liquid crystal portion 125.

The substrate portion 121 may include a rigid substrate, a flexible substrate, or a rigid-flexible substrate, and may include a glass substrate.

In the case in which the substrate portion 121 is implemented as a flexible substrate, the display device 100 may be curved with a certain curvature.

The color filter unit 122 may be positioned adjacent to the second polarizing panel 120c and/or the second substrate 121b.

The color filter portion 122 may be positioned adjacent to the first electrode portion 123.

The color filter portion 122 may convert incident light into red light, green light, and blue light, and cause the converted light to be emitted.

The color filter portion 122 may include a red filter (R) 122a that converts incident light into red light, a green filter (G) 122b that converts incident light into green light, and a blue filter (B) 122c that converts incident light into blue light.

Here, the red filter 122a, the green filter 122b, and the blue filter 122c may be arranged adjacent to each other and form an RGB filter. Also, the RGB filter may be included in a pixel.

A black matrix (not shown) may be provided at a border of each RGB filter. The black matrix may act as a light shield between color filters to prevent color expression and light leakage and enhance color contrast.

The color filter portion 122 may emit a color by emitting at least one of a red light emitted from the red filter 122a, green light emitted from the green filter 122b, or blue light emitted from the blue filter 122c to the outside, or may mix at least two of red light emitted from the red filter 122a, green light emitted from the green filter 122b, and blue light emitted from the blue filter 122c and emit the mixed light to the outside, thereby expressing a color.

Light converted in each filter of the color filter portion 122 may be emitted to the outside through the second polarizing panel 120c.

The first electrode portion 123 may be positioned between the second substrate 121b and the liquid crystal portion 125.

The first electrode portion 123 may be positioned between the color filter portion 122 and the liquid crystal portion 125.

The first electrode portion 123 may be a common electrode including no common slit.

The first electrode portion 123 may be a ground electrode.

A preset reference voltage may be applied to the first electrode portion 123.

An electrical field may be formed between the first electrode portion 123 and the second electrode portion 124.

The first electrode portion 123 may align liquid crystal molecules in the liquid crystal portion 125 by an electrical field formed in the liquid crystal portion 125.

The second electrode portion 124 may be positioned adjacent to the first substrate 121a.

The second electrode portion 124 may be positioned between the first substrate 121a and the liquid crystal portion 125.

The second electrode portion 124 may include a pixel electrode that forms an electric field by using an electric force of the first electrode portion 123.

The pixel electrode may be provided to correspond to each pixel. The pixel electrode may be provided to correspond to each RGB filter.

The pixel electrode may include a sub pixel electrode corresponding to a red filter, a sub pixel electrode corresponding to a green filter, and a sub pixel electrode corresponding to a blue filter. That is, each sub pixel electrode of the second electrode portion 124 may be positioned to correspond to each of the red filter, the green filter, and the blue filter of the color filter portion 122.

The same voltage or different voltages may be applied to a plurality of sub pixel electrodes of the second electrode portion 124.

A voltage that is identical to or different from the reference voltage may be applied to each sub pixel electrode.

For example, in the case in which the reference voltage is a voltage a, a voltage between a voltage b and a voltage c may be applied to the second electrode portion 124. The voltage b may be lower than the voltage a, and the voltage c may be higher than the voltage a. Also, the voltage a may be a voltage between the voltage b and the voltage c.

Due to a difference between a voltage applied to the sub pixel electrodes and a voltage applied to the common electrodes, an electric field may be formed in the liquid crystal portion 125.

A magnitude of an electric field formed in the liquid crystal portion 125 may depend on a difference between a voltage applied to the sub pixel electrodes and a voltage applied to the common electrodes.

Depending on a voltage applied to the sub pixel electrodes, a direction of electric field lines of an electric field formed in the liquid crystal portion 125 may be set, or no electric field may be formed in the liquid crystal portion 125.

The plurality of sub pixel electrodes of the second electrode portion 124 may share the first electrode portion 123.

The second electrode portion 124 may face the first electrode portion 123 with the liquid crystal portion 125 in between.

The plurality of sub pixel electrodes of the second electrode portion 124 may be implemented by using a thin film transistor (TFT).

The liquid crystal portion 125 may be positioned between the first electrode portion 123 and the second electrode portion 124 and include a plurality of liquid crystals. Here, the liquid crystals may be liquid crystal molecules.

When no electric field is formed in the liquid crystal portion 125, liquid crystals may be arranged randomly. When an electric field is formed liquid crystal portion 125, liquid crystals may be aligned according to a direction of the formed electric field.

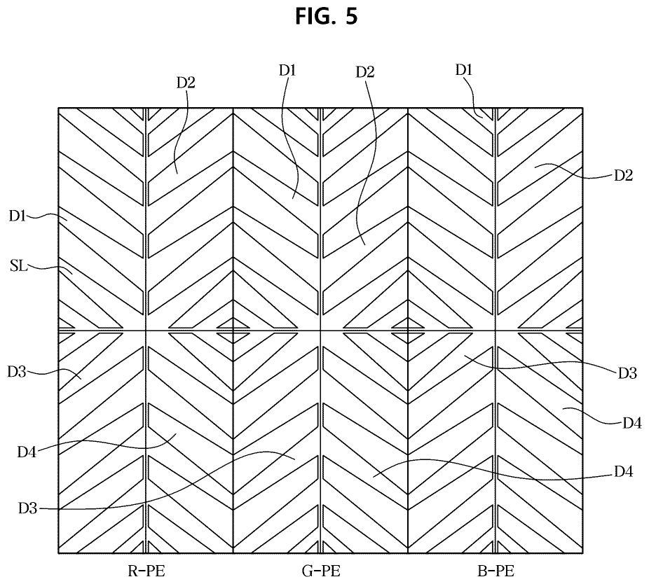

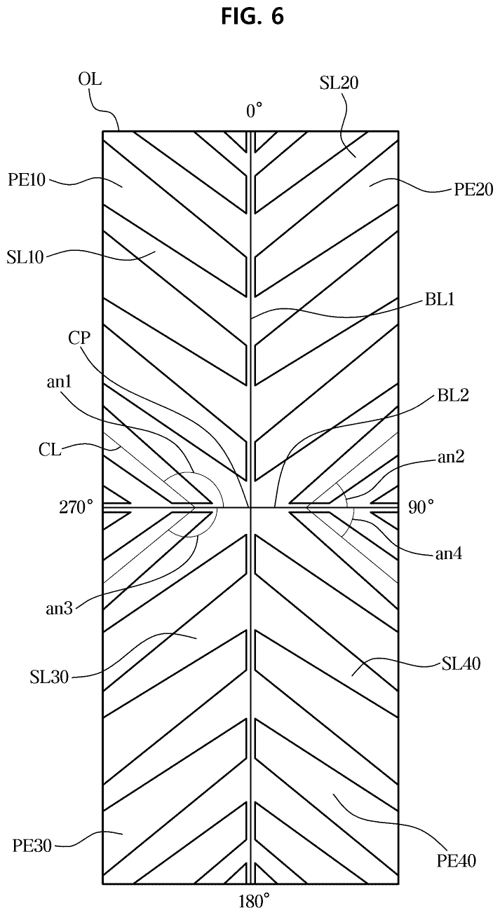

FIG. 5 is an example diagram of a pixel electrode provided in a display panel of a display device according to an embodiment. FIG. 5 will be described with reference to FIGS. 6 to 16.

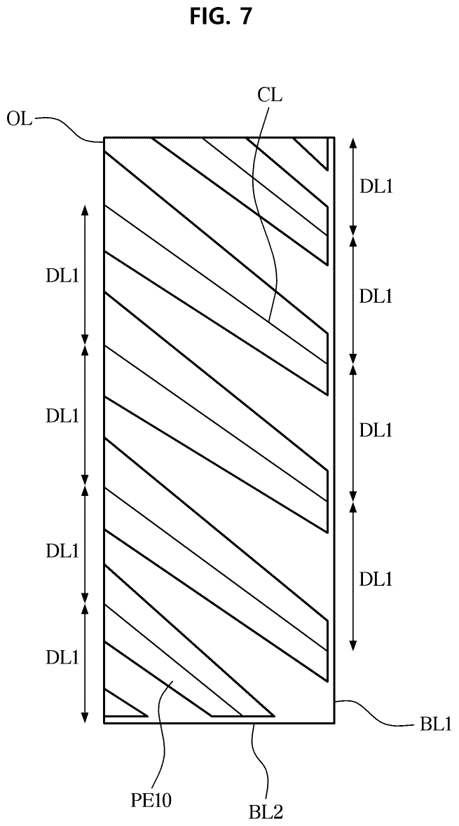

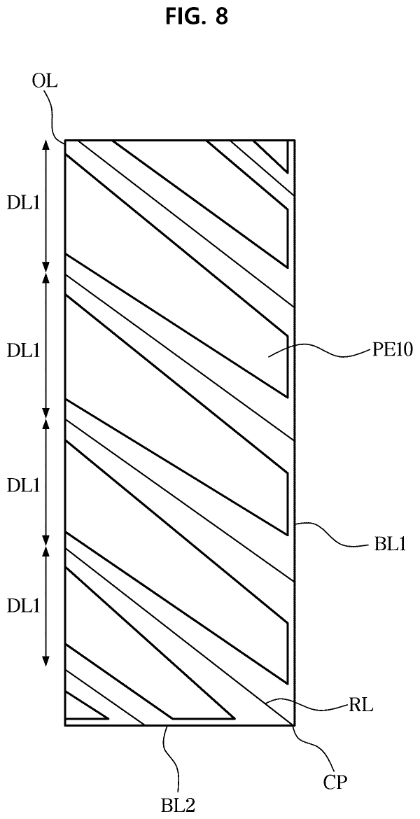

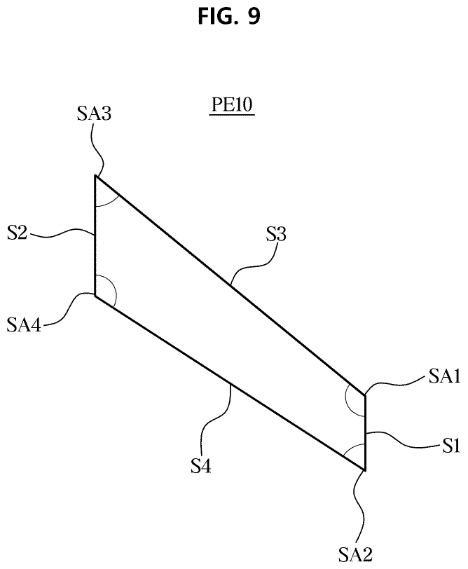

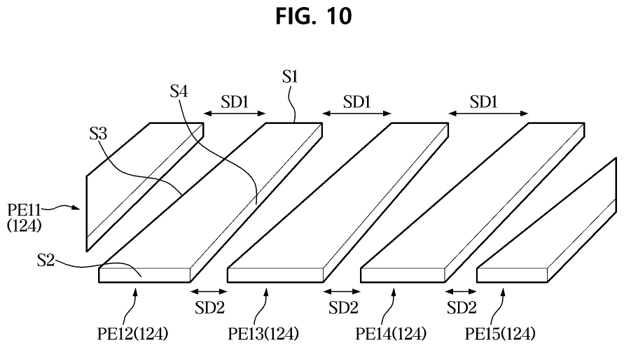

FIG. 6 is an example diagram of a sub pixel electrode provided in a display panel of a display device according to an embodiment. FIGS. 7 and 8 are example diagrams of a sub pixel electrode of a first domain provided in a display panel of a display device according to an embodiment. FIG. 9 is an example diagram of a split pixel electrode provided in a display panel of a display device according to an embodiment. FIG. 10 is an example arrangement diagram of split pixel electrodes of a first domain provided in a display panel of a display device according to an embodiment.

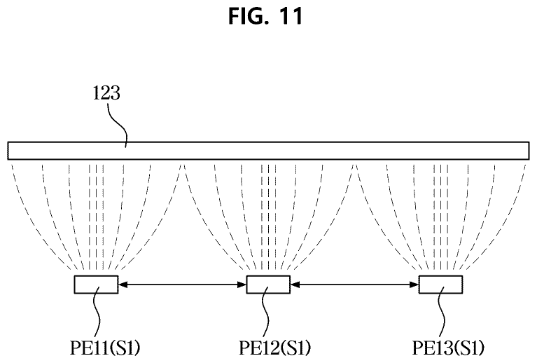

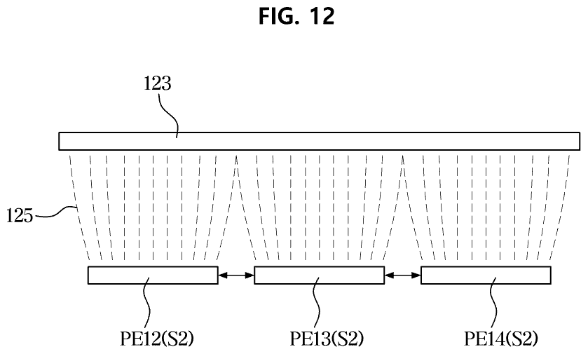

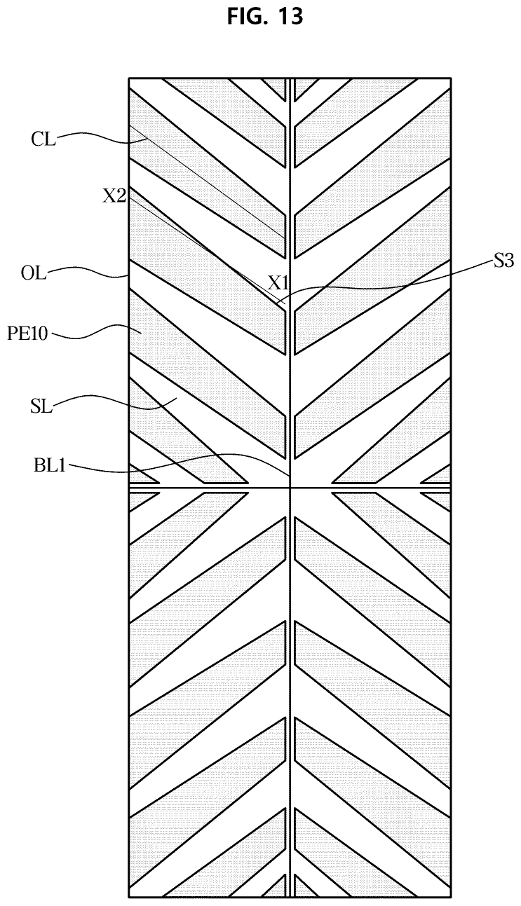

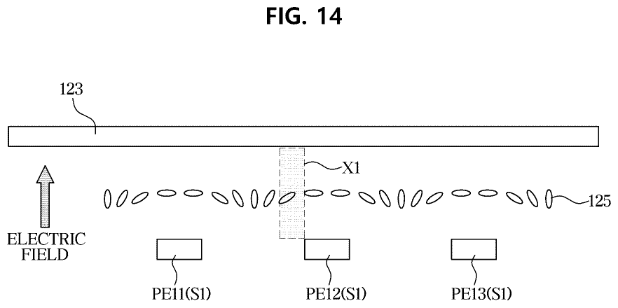

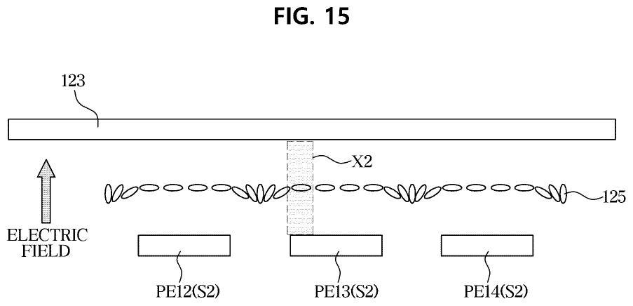

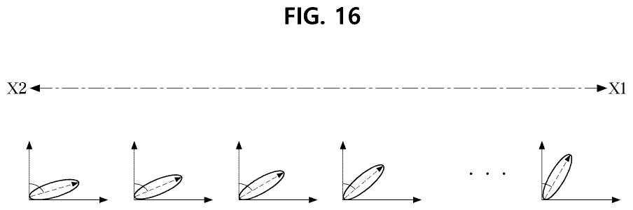

FIGS. 11 and 12 are example diagrams of electric fields between common electrodes and sub-pixel electrodes provided in a display panel of a display device according to an embodiment, FIG. 13 is an example diagram of a light output of a sub pixel provided in a display panel of a display device according to an embodiment, FIGS. 14 and 15 are example diagrams of liquid crystal alignments between common electrodes and sub pixel electrodes provided in a display panel of a display device according to an embodiment, and FIG. 16 shows an example diagram of a liquid crystal alignment taken along line X1-X2 of FIG. 13.

The display panel 120 may include a plurality of pixels.

Each pixel may include first, second, and third sub pixels.

A first sub pixel may be a sub pixel corresponding to a red filter R, a second sub pixel may be a sub pixel corresponding to a green filter G, and a third sub pixel may be a sub pixel corresponding to a blue filter B.

The first, second, and third sub pixels may be provided to respectively correspond to sub pixel electrodes of the second electrode portion 124.

As shown in FIG. 5, each of the sub pixel electrodes of the second electrode portion 124 may be divided into a plurality of domains D1, D2, D3, and D4.

A sub pixel electrode for each sub pixel may be divided into a sub pixel electrode of a first domain D1, a sub pixel electrode of a second domain D2, a sub pixel electrode of a third domain D3, and a sub pixel electrode of a fourth domain D4.

In each of the sub pixel electrodes of the first, second, third, and fourth domains D1 to D4, one or at least two pixel slits SL may be provided.

A sub pixel electrode of each domain may be split into a plurality of split pixel electrodes by the one or at least two pixel slits SL.

The pixel slits SL provided in the sub pixel electrodes of the respective domains may have different slopes.

The plurality of split pixel electrodes of the respective domains may have different arrangements depending on the slopes of the pixel slits SL, and electric fields of the respective domains may be formed in different directions to correspond to the arrangements of the split pixel electrodes for the respective domains. Also, the liquid crystals may be aligned in different directions depending on the slopes of the pixel slits SL for the respective domains.

A configuration of a pixel electrode corresponding to each of the first, second, and third sub pixels will be described in more detail.

As shown in FIG. 5, a sub pixel electrode R-PE corresponding to the first sub pixel may be divided into first, second, third, and fourth domains D1 to D4. That is, the sub pixel electrode R-PE may be divided into a sub pixel electrode of the first domain D1, a sub pixel electrode of the second domain D2, a sub pixel electrode of the third domain D3, and a sub pixel electrode of the fourth domain D4.

The sub pixel electrode R-PE may be provided with pixel slits SL for each domain. The pixel slits SL provided in the sub pixel electrode R-PE may have different slopes depending on the respective domains.

The sub pixel electrode R-PE of the first, second, third, and fourth domains D1 to D4 may be split into a plurality of split pixel electrodes by the pixel slits SL.

The sub pixel electrode R-PE of the first, second, third, and fourth domains D1 to D4 may be split into split pixel electrodes having different slopes according to the respective domains by the slopes of the pixel slits SL of the domains.

A sub pixel electrode G-PE corresponding to the second sub pixel may be divided into first, second, third, and fourth domains D1 to D4. That is, the sub pixel electrode G-PE may be divided into a sub pixel electrode of the first domain D1, a sub pixel electrode of the second domain D2, a sub pixel electrode of the third domain D3, and a sub pixel electrode of the fourth domain D4.

The sub pixel electrode G-PE may be provided with pixel slits SL for each domain. The pixel slits SL provided in the sub pixel electrode G-PE may have different slopes according to the respective domains.

The sub pixel electrode G-PE of the first, second, third, and fourth domains D1 to D4 may be split into a plurality of split pixel electrodes by the pixel slits SL.

The sub pixel electrode G-PE of the first, second, third, and fourth domains D1 to D4 may be split into split pixel electrodes having different slopes according to the respective domains by the slopes of the pixel slits SL of the domains.

A sub pixel electrode B-PE corresponding to the third sub pixel may be divided into first, second, third, and fourth domains D1 to D4. That is, the sub pixel electrode B-PE may be divided into a sub pixel electrode of the first domain D1, a sub pixel electrode of the second domain D2, a sub pixel electrode of the third domain D3, and a sub pixel electrode of the fourth domain D4.

The sub pixel electrode B-PE may be provided with pixel slits SL for each domain. The pixel slits SL provided in the sub pixel electrode B-PE may have different slopes according to the respective domains.

The sub pixel electrode B-PE of the first, second, third, and fourth domains D1 to D4 may be split into a plurality of split pixel electrodes by the pixel slits SL.

The sub pixel electrode B-PE of the first, second, third, and fourth domains D1 to D4 may be split into split pixel electrodes having different slopes according to the respective domains by the slopes of the pixel slits SL of the domains.

The split pixel electrodes in the sub pixel electrode R-PE, the sub pixel electrode G-PE, and the sub pixel electrode B-PE may have the same arrangement for each domain.

Hereinafter, an arrangement configuration of split pixel electrodes of each domain in a pixel electrode will be described.

As shown in FIG. 6, a sub pixel electrode of the first domain D1 may include a plurality of split pixel electrodes PE10 arranged at a slope corresponding to a first reference slope of first pixel slits SL10.

A sub pixel electrode of the second domain D2 may include a plurality of split pixel electrodes PE20 arranged at a slope corresponding to a second reference slope of second pixel slits SL20.

A sub pixel electrode of the third domain D3 may include a plurality of split pixel electrodes PE30 arranged at a slope corresponding to a third reference slope of third pixel slits SL30.

A sub pixel electrode of the fourth domain D4 may include a plurality of split pixel electrodes PE40 arranged at a slope corresponding to a fourth reference slope of fourth pixel slits SL40.

A plurality of split pixel electrodes of the respective domains may have different reference slopes with respect to a center point CP of the plurality of domains. That is, the plurality of split pixel electrodes of the respective domains may have the same reference slope or different reference slopes.

Also, a plurality of split pixel electrodes of each domain may be arranged at the same or similar angles to correspond to the slopes.

In each domain, an angle of a slope of each split pixel electrode may be an angle between a center line of the split pixel electrode and a boundary line of the domains.

Here, the boundary line of the domains may be a line for diving the domains and may be a line corresponding to a boundary between adjacent domains.

The boundary line of the domains may be a center line of the sub pixel electrode. The center line of the sub pixel electrode may include a vertical center line and a horizontal center line of the sub pixel electrode.

The center line of the split pixel electrode may be a center line between two long sides of the split pixel electrode, which face each other, and is referred to as a center line CL.

The center line CL may be a line connecting a center of a first side of the split pixel electrode to a center of a second side of the split pixel electrode. The first side of the split pixel electrode may be a side adjacent to a first boundary line BL1 or a second boundary line BL2. The second side of the split pixel electrode may be a side adjacent to an outer line OL of the sub pixel electrode.

That the angles corresponding to the slopes of the center lines of the split pixel electrodes are similar to each other may include a case in which a difference between an angle corresponding to a slope of a center line of any split pixel electrode and a reference angle falls within a reference difference range.

For example, an angle an1 of a center line of each of the plurality of first split pixel electrodes PE10 arranged in the first domain D1 may be an angle between −90 degrees and 0 degrees (or an angle between 270 degrees and 0 degrees). A first reference angle for the first domain D1 may be about-45 degrees or about 315 degrees.

An angle an2 of a center line of each of the plurality of second split pixel electrodes PE20 arranged in the second domain D2 may be an angle between 0 degrees and 90 degrees. A second reference angle for the second domain D2 may be about 45 degrees.

An angle an4 of a center line of each of the plurality of fourth split pixel electrodes PE40 arranged in the fourth domain D4 may be an angle between 90 degrees and 180 degrees. A third reference angle for the fourth domain D4 may be about 135 degrees.

An angle an3 of a center line of each of the plurality of third split pixel electrodes PE30 arranged in the third domain D3 may be an angle between 180 degrees and 270 degrees (or an angle between −180 degrees and −90 degrees). A fourth reference angle for the third domain D3 may be about 225 degrees.

A reference difference range for each domain may be between −45 degrees and 45 degrees.

The plurality of split pixel electrodes provided in the first, second, third, and fourth domains D1, D2, D3, and D4 may be arranged symmetrically with respect to the first boundary line BL1 and may be arranged symmetrically with respect to the second boundary line BL2.

More specifically, an arrangement of the first split pixel electrodes PE10 of the first domain D1 may be symmetrical to that of the second split pixel electrodes PE20 of the second domain D2 with respect to the first boundary line BL1.

The arrangement of the first split pixel electrodes PE10 of the first domain D1 may be symmetrical to that of the third split pixel electrodes PE30 of the third domain D3 with respect to the second boundary line BL2.

An arrangement of the second split pixel electrodes PE20 of the second domain D2 may be symmetrical to that of the fourth split pixel electrodes PE40 of the fourth domain D4 with respect to the second boundary line BL2.

The arrangement of the third split pixel electrodes PE30 of the third domain D3 may be symmetrical to that of the fourth split pixel electrodes PE40 of the fourth domain D4 with respect to the first boundary line BL1.

The first boundary line BL1 may be a vertical boundary line for separating the first domain D1 from the second domain D2 and separating the third domain D3 from the fourth domain D4.

The first boundary line BL1 may be a vertical center line of the sub pixel electrode.

The second boundary line BL2 may be a horizontal boundary line for separating the first domain D1 from the third domain D3 and separating the second domain D2 from the fourth domain D4.

The second boundary line BL2 may be a horizontal center line of the sub pixel electrode.

The first boundary line BL1 and the second boundary line BL2 may be imaginary lines. The center line CL may be an imaginary line.

The plurality of split pixel electrodes provided in the first, second, third, and fourth domains D1, D2, D3, and D4 may be identical to each other in shape and arrangement configuration even if the split pixel electrodes are arranged at different reference angles in the first to fourth domains D1, D2, D3, and D4.

Hereinafter, the plurality of split pixel electrodes PE10 of the first domain D1 will be described as an example.

As shown in FIG. 7, each of the plurality of split pixel electrodes PE10 provided in the first domain D1 may have a polygonal shape.

The polygonal shape may include a quadrangular or trapezoidal shape and may further include a triangular shape.

Each of the plurality of split pixel electrodes PE10 provided in the first domain D1 may have a saw blade shape.

Each of the plurality of split pixel electrodes PE10 may be aligned based on the center line CL.

The center line CL of each of the plurality of split pixel electrodes PE10 may form a first reference angle with respect to the first boundary line BL1.

The plurality of split pixel electrodes PE10 provided in the first domain D1 may be arranged such that portions of plurality of split pixel electrodes PE10 are spaced a preset distance DL1 from each other.

The preset distance DL1 may be a distance between center lines CL of neighboring split pixel electrodes PE10 along a direction of the first boundary line BL1.

As shown in FIG. 8, the plurality of split pixel electrodes PE10 provided in the first domain D1 may be arranged between reference lines RL having the first reference slope, wherein the reference lines RL are spaced the preset distance DL1 from each other.

The first reference slope of the reference lines RL may be the same as a slope of the center line CL of each of the plurality of split pixel electrodes PE10.

The plurality of split pixel electrodes PE10 provided in the first domain D1 may be arranged between the plurality of reference lines RL.

The reference lines RL may be provided in a plurality of pixel slits. The respective reference lines RL may be provided at respective centers of the plurality of pixel slits. That is, a reference line RL may be provided between two long sides of a pixel slit.

The reference lines RL may be imaginary lines. The reference lines RL may be lines for generating the split pixel electrodes PE10.

One of the reference lines RL may be generated to have the first reference slope from the center CP of the domains, and the remaining reference lines may be generated by being spaced the preset distance DL1 from the one reference line RL.

The center CP of the domains may be a point where the first boundary line BL1 and the second boundary line BL2 intersect perpendicularly.

In each domain, a width of each of the plurality of pixel slits on the first boundary line BL1 of the sub pixel electrode may be greater than a width of each of the plurality of pixel slits on the outer line OL of the sub pixel electrode.

In each domain, the width of each of the plurality of pixel slits may decrease toward the outer line OL from the first boundary line BL1. Therefore, a width of each of the plurality of split pixel electrodes may increase toward the outer line OL from the first boundary line BL1.

A plurality of pixel slits of adjacent domains may have symmetrical arrangements based on the first boundary line BL1 or the second boundary line BL2.

An arrangement of the plurality of pixel slits of the first domain D1 may be symmetrical to that of a plurality of pixel slits of the second domain D2 with respect to the first boundary line BL1.

The arrangement of the plurality of pixel slits of the first domain D1 may be symmetrical to that of a plurality of pixel slits of the third domain D3 with respect to the second boundary line BL2.

The arrangement of the plurality of pixel slits of the second domain D2 may be symmetrical to that of a plurality of pixel slits of the fourth domain D4 with respect to the second boundary line BL2.

The arrangement of the plurality of pixel slits of the third domain D3 may be symmetrical to that of the plurality of pixel slits of the fourth domain D4 with respect to the first boundary line BL1.

As shown in FIG. 9, each of the plurality of split pixel electrodes PE10 may include a first side S1 that is adjacent to the first or second boundary line BL1 or BL2, a second side S2 that faces the first side S1 and is adjacent to the outer line OL of the sub pixel, a third side S3 that connects a first end of the first side S1 to a first end of the second side S2, and a fourth side S4 that connects a second end of the first side S1 to a second end of the second side S2.

A first width of the first side S1 of each of the plurality of split pixel electrodes PE10 may be smaller than a second width of the second side S2.

An internal angle SA1 formed by the first side S1 and the third side S3 may be an obtuse angle, and an internal angle SA2 formed by the first side S1 and the fourth side S4 may be an acute angle.

An internal angle SA3 formed by the second side S2 and the third side S3 may be an acute angle, and an internal angle SA4 formed by the second side S2 and the fourth side S4 may be an obtuse angle.

A part of the plurality of split pixel electrodes PE10 provided in the first domain D1 may have the same area, and a remaining part may have different areas.

As shown in FIG. 10, the plurality of split pixel electrodes PE10 of the second electrode portion 124 provided in the first domain D1 may be arranged horizontally to the substrate portion 121.

The plurality of split pixel electrodes PE10 may include a first split pixel electrode PE11, a second split pixel electrode PE12, a third split pixel electrode PE13, a fourth split pixel electrode PE14, and a fifth split pixel electrode PE15.

The plurality of split pixel electrodes PE10 may be spaced from each other with a pixel slit SL in between.

First sides S1 of neighboring split pixel electrodes PE10 positioned adjacent to the first boundary line BL1 may be spaced a first reference distance SD1 from each other, and second sides S2 of neighboring split pixel electrodes PE10 positioned adjacent to the outer line OL may be spaced a second reference distance SD2 from each other.

The first sides S1 of the neighboring split pixel electrodes PE10 positioned adjacent to the first boundary line BL1 may include first sides S1 of the first, second, third, and fourth split pixel electrodes PE11, PE12, PE13, and PE14.

The second sides S2 of the neighboring split pixel electrodes PE10 positioned adjacent to the outer line OL may include second sides S2 of the second, third, fourth, and fifth split pixel electrodes PE12, PE13, PE14, and PE15.

For example, a distance between the first side S1 of the first split pixel electrode PE11 and the first side S1 of the second split pixel electrode PE12 may be the first reference distance SD1, a distance between the first side S1 of the second split pixel electrode PE12 and the first side S1 of the third split pixel electrode PE13 may be the first reference distance SD1, and a distance between the first side S1 of the third split pixel electrode PE13 and the first side S1 of the fourth split pixel electrode PE14 may be the first reference distance SD1.

A distance between the second side S2 of the second split pixel electrode PE12 and the second side S2 of the third split pixel electrode PE13 may be the second reference distance SD2, a distance between the second side S2 of the third split pixel electrode PE13 and the second side S2 of the fourth split pixel electrode PE14 may be the second reference distance SD2, and a distance between the second side S2 of the fourth split pixel electrode PE14 and the second side S2 of the fifth split pixel electrode PE15 may be the second reference distance SD2.

As shown in FIGS. 11 and 12, the plurality of split pixel electrodes PE11, PE12, PE13, PE14, and PE15 of the second electrode portion 124 provided in the first domain D1 may be spaced from the first electrode portion 123.

A spacing distance between the first electrode portion 123 and the second electrode portion 124 may correspond to a thickness of the liquid crystal portion 125.

When power is supplied to the first electrode portion 123 and the second electrode portion 124, an electric field may be formed between the first electrode portion 123 and the second electrode portion 124.

In the electric field, a plurality of electric field lines may be formed, which are paths along which positive charges move in a direction of an applied force. The electric field lines may start at a high potential and end at a low potential.

That is, according to one or more embodiments, an electric field in which charges flow out from the second electrode portion 124 at a high potential and flow into the first electrode portion 123 at a low potential may be formed.

The plurality of electric field lines may move vertically from a surface of the second electrode portion 124 at the high potential, and while the electric field lines move, the electric field lines may change a direction toward the first electrode portion 123 at the low potential and move. The plurality of electric field lines may neither split nor intersect each other while moving. Also, the electric field lines may have a characteristic of gathering at corners of the first and second electrode portions 123 and 124.

An electric field may be formed between the first electrode portion 123 and the plurality of split pixel electrodes of the second electrode portion 124.

The electric field formed between the first electrode portion 123 and the plurality of split pixel electrodes of the second electrode portion 124 may correspond to shapes of the split pixel electrodes.

That is, electric field lines of an electric field at the first sides S1 of the plurality of split pixel electrodes may be different from electric field lines of an electric field at the second sides S2 of the plurality of split pixel electrodes.

As shown in FIG. 11, an electric field may be formed between the first sides S1 of the split pixel electrodes and the first electrode portion 123.

Electric force lines (or electric field lines) each having a substantially straight shape may be formed between the first sides S1 of the split pixel electrodes and the first electrode portion 123.

The electric force lines each having the substantially straight shape may be formed at areas corresponding to the first widths of the first sides S1 of the split pixel electrodes.

A plurality of electric field lines each having a substantially diagonal shape or a substantially parabolic shape may be formed between corners of the first sides S1 of the split pixel electrodes and the first electrode portion 123.

The electric force lines formed at the corners of the first sides S1 of the split pixel electrodes may be formed up to surface positions corresponding to half of the first reference distance SD1 on a surface of the first electrode portion 123.

The electric force lines formed at the corners of the first sides S1 of the split pixel electrodes may be formed with lower slopes toward the surface positions corresponding to half of the first reference distance SD1 from surface positions corresponding to the corners of the first sides S1 on the surface of the first electrode portion 123.

The electric force lines formed at the corners of the first sides S1 of the split pixel electrodes may not intersect each other.

As shown in FIG. 12, an electric field may be formed between the second sides S2 of the split pixel electrodes and the first electrode portion 123.

A plurality of electric field lines each having a substantially straight shape may be formed between the second sides S2 of the split pixel electrodes and the first electrode portion 123.

The electric field lines each having the substantially straight shape may be formed at areas corresponding to the second widths of the second sides S2 of the split pixel electrodes.

A plurality of electric field lines each having a substantially diagonal shape or a substantially parabolic shape may be formed between corners of the second sides S2 of the split pixel electrodes and the first electrode portion 123.

The electric force lines formed at the corners of the second sides S2 of the split pixel electrodes may be formed up to surface positions corresponding to half of the second reference distance SD2 on the surface of the first electrode portion 123.

The electric force lines formed at the corners of the second sides S2 of the split pixel electrodes may be formed with lower slopes toward the surface positions corresponding to half of the second reference distance SD2 from surface positions corresponding to the corners of the second sides S2 on the surface of the first electrode portion 123.

The electric force lines formed at the corners of the second sides S2 of the split pixel electrodes may not intersect each other.

An amount of the electric field lines each having the straight line and formed at the second sides S2 of the split pixel electrodes may be greater than an amount of the electric field lines each having the straight line and formed at the first sides S1 of the split pixel electrodes.

The slopes of the electric field lines each having the substantially diagonal shape and formed at the corners of the first sides S1 of the split pixel electrodes may be lower than those of the electric field lines each having the diagonal shape and formed at the corners of the second sides S2 of the split pixel electrodes.

A minimum one of the slopes of the electric field lines each having the diagonal shape and formed at the corners of the first sides S1 of the split pixel electrodes may be lower than a minimum one of the slopes of the electric field lines each having the diagonal shape and formed at the corners of the second sides S2 of the split pixel electrodes.

A distance between the electric field lines formed between the first sides S1 of the split pixel electrodes may be greater than a distance between the electric field lines formed between the second sides S2 of the split pixel electrodes.

When an electric field is formed, the liquid crystals of the liquid crystal portion 125 may be aligned based on electric field lines. That is, while no electric field is formed, the liquid crystals of the liquid crystal portion 125 may be aligned vertically between the first and second electrode portions 123 and 124, and when an electric field is formed, the liquid crystals of the liquid crystal portion 125 may be aligned horizontally between the first and second electrode portions 123 and 124 to correspond to electric field lines.

As shown in FIG. 13, when an electric field is formed between the first and second electrode portions 123 and 124, light may be emitted through areas corresponding to the sub pixel electrodes PE10 of the second electrode portion 124 among areas of the sub pixels. Also, dark parts may be formed in areas corresponding to the pixel slits SL of the second electrode portion 124 among the areas of the sub pixels.

As shown in FIG. 14, the liquid crystals of the liquid crystal portion 125 may be aligned horizontally in areas corresponding to flat surfaces of the first sides S1 of the split pixel electrodes PE11, PE12, and PE13 of the second electrode portion 124 among areas of the liquid crystal portion 125, and in areas corresponding to the corners of the first sides S1 of the split pixel electrodes PE11, PE12, and PE13, the liquid crystals of the liquid crystal portion 125 may be aligned substantially horizontally (or parallel) to electric field lines to correspond to a direction in which the electric field lines are formed.

An alignment angle of the liquid crystals on the flat surfaces of the first sides S1 of the split pixel electrodes PE11, PE12, and PE13 of the second electrode portion 124 may be different from an alignment angle of the liquid crystals at the corners of the first sides S1 of the split pixel electrodes PE11, PE12, and PE13 of the second electrode portion 124.

As shown in FIG. 15, the liquid crystals of the liquid crystal portion 125 may be aligned horizontally in areas corresponding to flat surfaces of the second sides S2 of the split pixel electrodes PE12, PE13, and PE14 of the second electrode portion 124 among the areas of the liquid crystal portion 125, and in areas corresponding to the corners of the second sides S2 of the split pixel electrodes PE12, PE13, and PE14, the liquid crystals of the liquid crystal portion 125 may be aligned substantially horizontally (or parallel) to electric field lines to correspond to the direction in which the electric field lines are formed.

An alignment angle of the liquid crystals on the flat surfaces of the second sides S2 of the split pixel electrodes PE12, PE13, and PE14 of the second electrode portion 124 may be different from an alignment angle of the liquid crystals at the corners of the second sides S2 of the split pixel electrodes PE12, PE13, and PE14 of the second electrode portion 124.

A width of each of split pixel electrodes forming a sub pixel electrode in one domain may increase toward the outer line OL from the first boundary line BL1 of the domains.

A distance between the split pixel electrodes PE12, PE13, and PE13 forming a sub pixel electrode in one domain may decrease toward the outer line OL from the first boundary line BL1 of the domains. A distance between a fourth side (e.g., S4 in FIG. 9) of any split pixel electrode and a third side (e.g., S3 in FIG. 9) of a neighboring split pixel electrode may decrease toward the outer line OL from the first boundary line BL1 of the domains.

As an area of a split pixel electrode increases toward the outer line OL from the first boundary line BL1, a strength of an electric field formed between the split pixel electrode and the common electrode may increase toward the outer line OL from the first boundary line BL1.

Accordingly, when an electric field is formed between the first electrode portion 123 and the second electrode portion 124, the liquid crystals may be aligned at different alignment angles at corners of third and fourth sides S3 and S4 of split pixel electrodes forming each sub pixel electrode.

As shown in FIGS. 13 to 16, an alignment angle of the liquid crystals around the third sides S3 of the split pixel electrodes forming a sub pixel electrode may increase toward the outer line OL from the first boundary line BL1 of the domains.

A line X1-X2 in FIG. 13 may be a line cutting a peripheral area of the third side S3 of a split pixel electrode, based on a first reference angle of a center line CL of the split pixel electrode and a position of the third side S3.

The first reference angle may be an angle at which the liquid crystals have maximum transmittance.

The first reference angle may be an angle that forms substantially 45 degrees with the polarization axis of the second polarizing panel 120c.

That is, a width of each split pixel electrode with respect to the center line CL may increase toward the outer line OL from the first boundary line BL1. Therefore, the liquid crystals around third and fourth sides S3 and S4 of the split pixel electrode may be aligned at different alignment angles.

An alignment angle of the liquid crystals at an area adjacent to the first boundary line BL1 in a peripheral area of the third side S3 of the split pixel electrode may be smaller than an alignment angle of the liquid crystals at an area adjacent to the outer line OL in the peripheral area of the third side S3 of the split pixel electrode.

Here, an alignment angle of the liquid crystals may be set based on an alignment angle of the liquid crystals aligned vertically. That is, an angle of the liquid crystals aligned vertically may be 0 degrees.

In one or more embodiments, by increasing a width of each split pixel electrode toward the outer line OL from the first boundary line BL1 of the domains based on the reference slope of the slits provided in the pixel electrode or the first reference angle of the center line CL of the split pixel electrode, an alignment angle of the liquid crystals may increase toward the outer line OL from the first boundary line BL1.

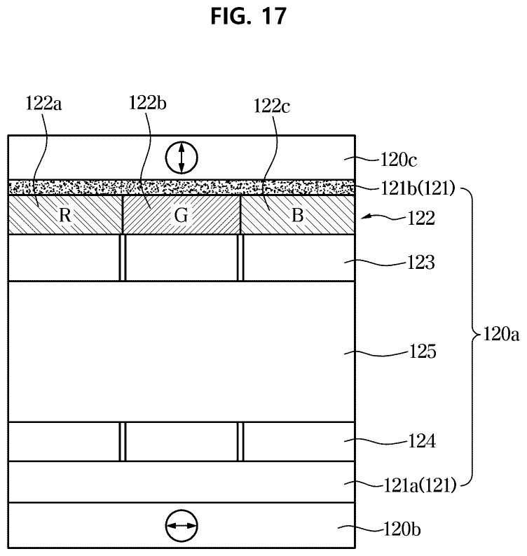

FIG. 17 is a detailed configuration diagram of a display panel provided in a display device according to another embodiment.

A display panel 120 of the display device according to another embodiment may include a liquid crystal panel 120a, a first polarizing panel 120b provided on one side of the liquid crystal panel 120a, and a second polarizing panel 120c provided on another side of the liquid crystal panel 120a.

The first polarizing panel 120b and the second polarizing panel 120c of the display device according to another embodiment may be the same as the first polarizing panel 120b and the second polarizing panel 120c of the display device according to one or more embodiments described above, and therefore, descriptions thereof will be omitted.

The liquid crystal panel 120a of the display device according to another embodiment may include a substrate portion 121, a color filter portion 122, a first electrode portion 123, a second electrode portion 124, and a liquid crystal portion 125.

The substrate portion 121, the second electrode portion 124, the liquid crystal portion 125, and the color filter portion 122 of the display device according to another embodiment may be the same as the substrate portion 121, the second electrode portion 124, the liquid crystal portion 125, and the color filter portion 122 of the display device according to one or more embodiments described above, and therefore, descriptions thereof will be omitted.

The first electrode portion 123 of the display device according to another embodiment may be positioned between the color filter portion 122 and the liquid crystal portion 125.

The first electrode portion 123 may form an electric field together with the second electrode portion 124.

The first electrode portion 123 may align liquid crystals in the liquid crystal portion 125 by the electric field formed in the liquid crystal portion 125.

The first electrode portion 123 may be a ground electrode.

A preset reference voltage may be applied to the first electrode portion 123.

The first electrode portion 123 may include a plurality of common electrodes.

The plurality of common electrodes of the first electrode portion 123 may respectively correspond to a plurality of sub pixel electrodes of the second electrode portion 124.

That is, positions of the plurality of common electrodes of the first electrode portion 123 may correspond to positions of the plurality of sub electrodes of the second electrode portion 124.

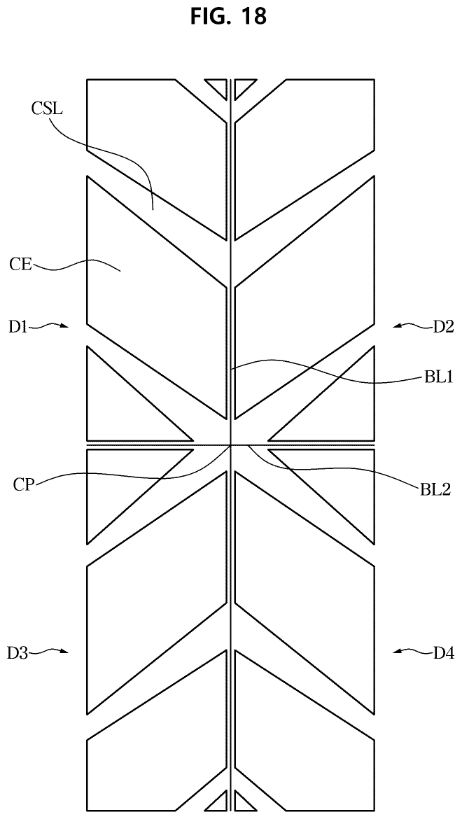

Each of the plurality of common electrodes may be split by a plurality of common slits. That is, each of the plurality of common electrodes may include a plurality of split common electrodes split by the common slits. This will be described with reference to FIGS. 18 to 30.

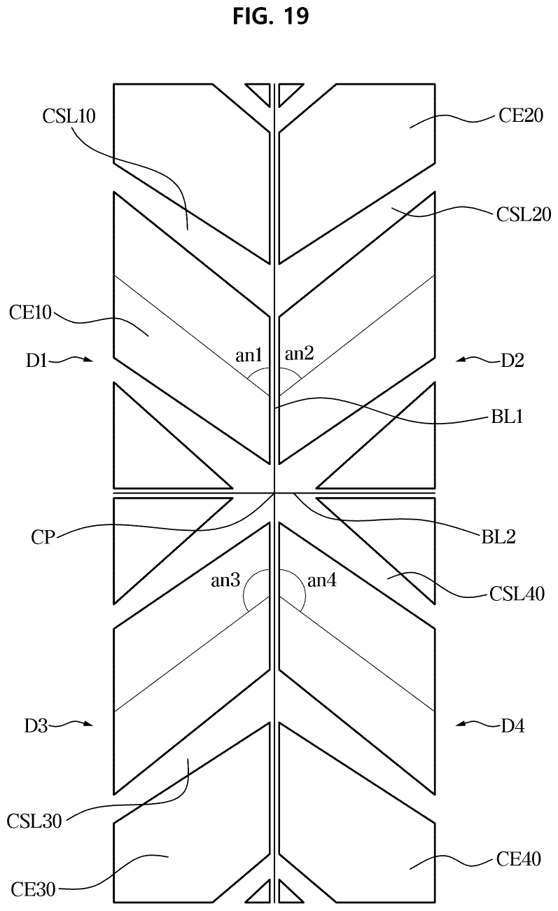

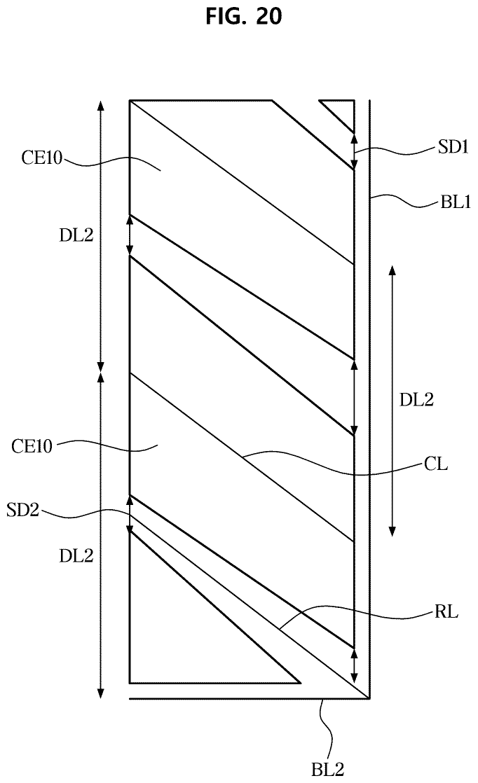

FIGS. 18 and 19 are example diagrams of a common electrode of a first electrode portion provided in a display panel of a display device according to another embodiment, and FIG. 20 is an example diagram of a common electrode of a first domain provided in a display panel of a display device according to another embodiment.

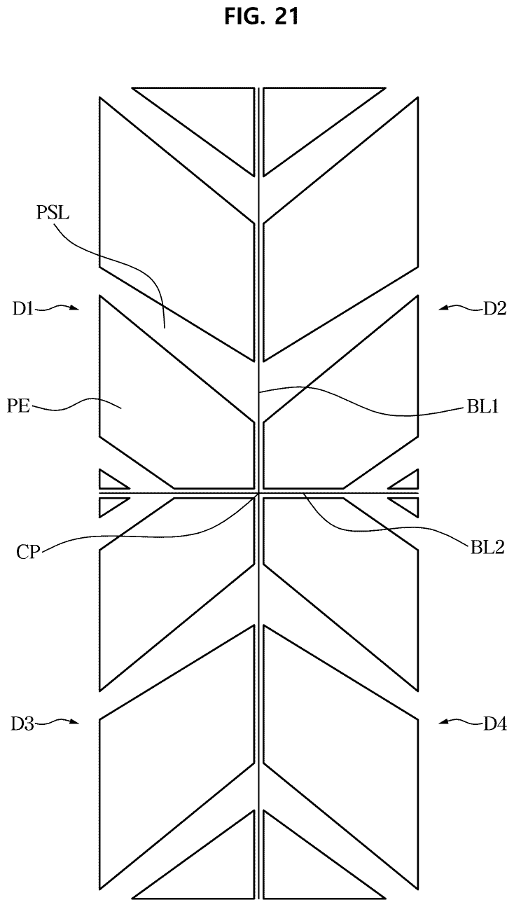

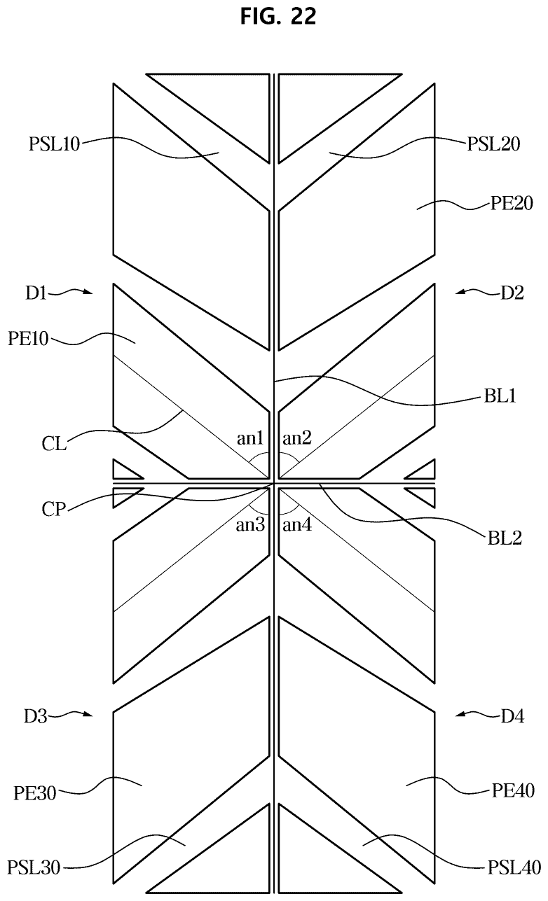

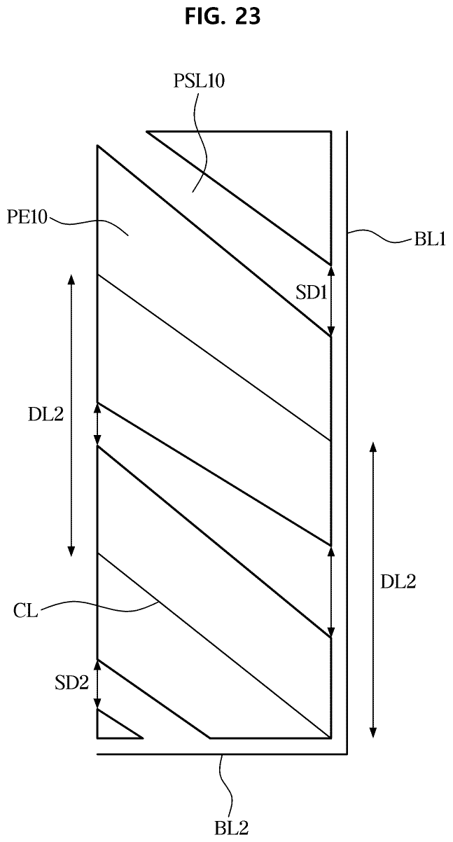

FIGS. 21 and 22 are example diagrams of a sub pixel electrode provided in a display panel of a display device according to another embodiment, and FIG. 23 is an example diagram of a sub pixel electrode of a first domain provided in a display panel of a display device according to another embodiment.

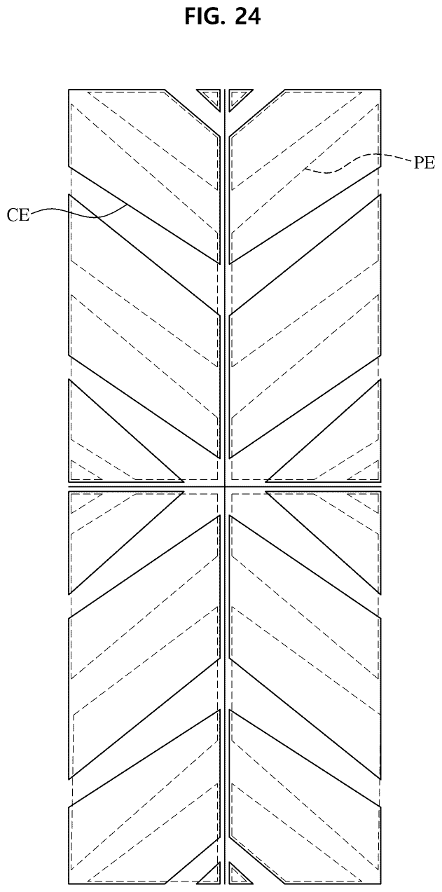

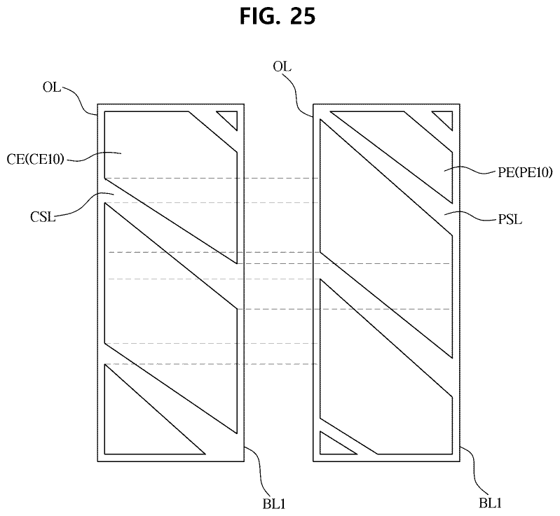

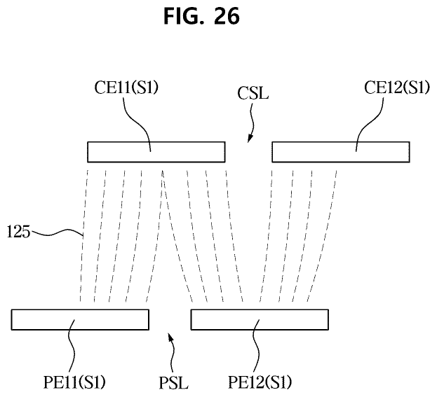

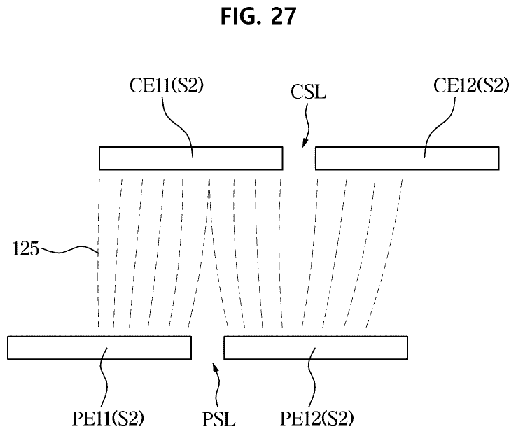

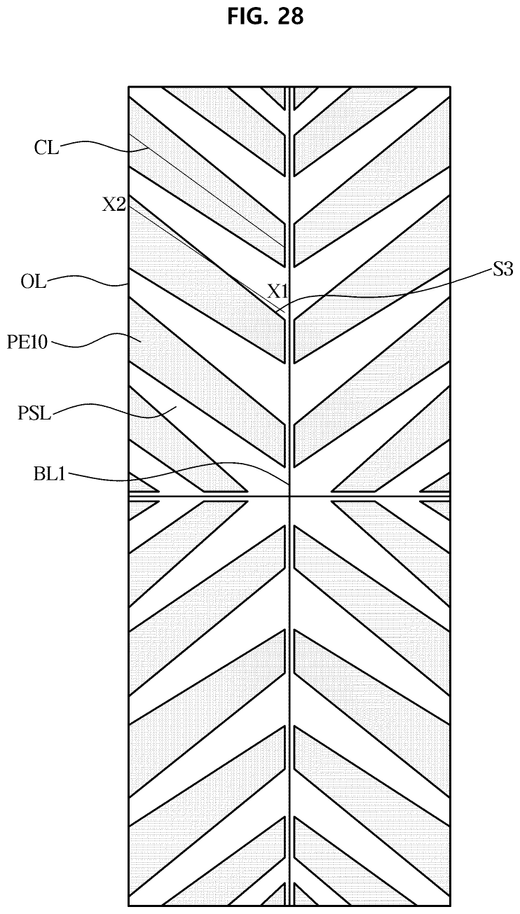

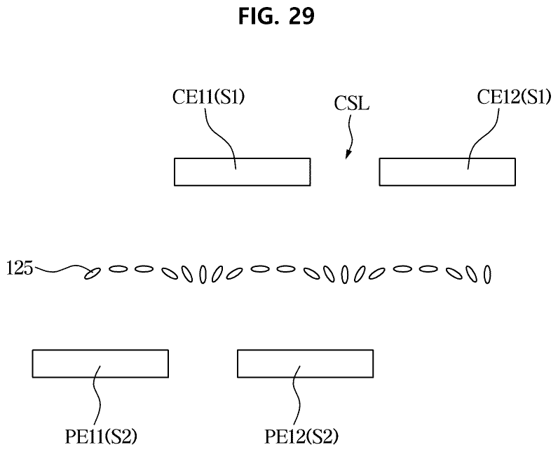

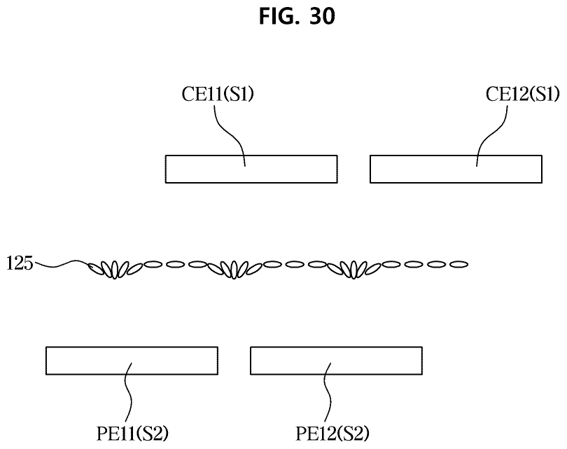

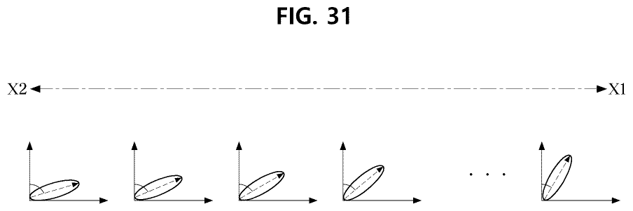

FIGS. 24 and 25 are example arrangement diagrams of common electrodes and sub pixel electrodes provided in a display panel of a display device according to another embodiment, FIGS. 26 and 27 are example diagrams of electrical fields between common electrodes and sub pixel electrodes provided in a display panel of a display device according to another embodiment, FIG. 28 is an example diagram of a light output of a sub pixel provided in a display panel of a display device according to another embodiment, FIGS. 29 and 30 are example diagrams of liquid crystal alignments between common electrodes and sub pixel electrodes provided in a display panel of a display device according to another embodiment, and FIG. 31 is an example diagram of a liquid crystal alignment taken along line X1-X2 of FIG. 28.

The plurality of common electrodes corresponding to the respective sub pixels may have the same configuration. Accordingly, a configuration of a common electrode corresponding to a sub pixel will be described.

As shown in FIG. 18, each common electrode CE may be divided into a plurality of domains D1, D2, D3, and D4.

The common electrode CE may be divided into a common electrode of a first domain D1, a common electrode of a second domain D2, a common electrode of a third domain D3, and a common electrode of a fourth domain D4.

In the common electrodes of the first, second, third, and fourth domains D1, D2, D3, and D4, one or at least two common slits CSL may be provided.

A common electrode CE of each domain may be split into a plurality of split common electrodes by the one or at least two common slits CSL.

The common slits CSL provided in the common electrodes CE of the respective domains may have different slopes.

The plurality of split common electrodes of the respective domains may have different arrangements to correspond to the slopes of the common slits CSL, and electric fields may be formed in different directions in the respective domains to correspond to the arrangements of the split common electrodes of the respective domains. Also, the liquid crystals may be aligned in different directions according to the slopes of the common slits CSL of the respective domains.

As shown in FIG. 19, the common electrode of the first domain D1 may include a plurality of split common electrodes CE10 arranged at a slope corresponding to a first reference slope of a plurality of first common slits CSL10.

The common electrode of the second domain D2 may include a plurality of split common electrodes CE20 arranged at a slope corresponding to a second reference slope of a plurality of second common slits CSL20.

The common electrode of the third domain D3 may include a plurality of split common electrodes CE30 arranged at a slope corresponding to a third reference slope of a plurality of third common slits CSL30.

The common electrode of the fourth domain D4 may include a plurality of split common electrodes CE40 arranged at a slope corresponding to a fourth reference slope of a plurality of fourth common slits CSLA0.

The plurality of split common electrodes of the respective domains may have different reference slopes with respect to a center CP of the plurality of domains. That is, reference slopes of a plurality of split common electrodes of each domain may be the same or similar to each other.

Also, angles corresponding to the slopes of a plurality of split common electrodes of each domain may be the same or similar to each other.

An angle of a slope of a split common electrode of each domain may be an angle between a center line of the split common electrode and a boundary line of the domains.

Here, the boundary line of the domains may be a line for diving adjacent domains and may be a line between the adjacent domains.

The boundary line of the domains may be a center line of the common electrode. The center line of the common electrode may include a vertical center line (e.g., a first boundary line BL1) and a horizontal center line (e.g., a second boundary line BL2).

The center line of the split common electrode may be a center line between two long sides of the split common electrode, which face each other, and is referred to as a center line CL.

That the angles corresponding to the slopes of the split common electrodes are similar to each other may include a case in which a difference between an angle corresponding to a slope of any split common electrode and a reference angle falls within a reference difference range.

For example, an angle an1 of a center line of each of the plurality of split common electrodes CE10 arranged in the first domain D1 may be an angle between −90 degrees and 0 degrees (or an angle between 270 degrees and 0 degrees). A first reference angle for the first domain D1 may be about-45 degrees or about 315 degrees.

An angle an2 of a center line of each of the plurality of second common electrodes CE20 arranged in the second domain D2 may be an angle between 0 degrees and 90 degrees. A second reference angle for the second domain D2 may be about 45 degrees.

An angle an4 of a center line of each of the plurality of fourth common electrodes CE40 arranged in the fourth domain D4 may be an angle between 90 degrees and 180 degrees. A fourth reference angle for the fourth domain D4 may be about 135 degrees.

An angle an3 of a center line of each of the plurality of third common electrodes CE30 arranged in the third domain D3 may be an angle between 180 degrees and 270 degrees (or an angle between −90 degrees and −180 degrees). A third reference angle for the third domain D3 may be about 225 degrees.

A reference difference range for each domain may be between −45 degrees and 45 degrees.

The plurality of split common electrodes provided in the first, second, third, and fourth domains D1, D2, D3, and D4 may be arranged symmetrically with respect to the first boundary line BL1 and may be arranged symmetrically with respect to the second boundary line BL2.

More specifically, an arrangement of the first split common electrodes CE10 of the first domain D1 may be symmetrical to that of the second split common electrodes CE20 of the second domain D2 with respect to the first boundary line BL1.

The arrangement of the first split common electrodes CE10 of the first domain D1 may be symmetrical to that of the third split common electrodes CE30 of the third domain D3 with respect to the second boundary line BL2.

An arrangement of the second split common electrodes CE20 of the second domain D2 may be symmetrical to that of the third split common electrodes CE40 of the third domain D3 with respect to the second boundary line BL2.

The arrangement of the third split common electrodes CE30 of the third domain D3 may be symmetrical to that of the fourth split common electrodes CE40 of the fourth domain D4 with respect to the first boundary line BL1.

The plurality of split common electrodes provided in the first, second, third, and fourth domains D1, D2, D3, and D4 may be identical to each other in shape and arrangement configuration even if the split common electrodes are arranged at different reference angles in the domains D1, D2, D3, and D4.

Hereinafter, the plurality of split common electrodes CE10 of the first domain D1 will be described as an example.

As shown in FIG. 20, each of the plurality of split common electrodes CE10 provided in the first domain D1 may have a polygonal shape.

Each of the plurality of split common electrodes CE10 provided in the first domain D1 may have a triangular shape, a quadrangular shape, or a pentagonal shape according to a shape of the first domain D1 and an arrangement of the split common electrodes CE10.

Each of the plurality of split common electrodes CE10 may be aligned based on the center line CL.

The center line CL of each of the plurality of split common electrodes CE10 may form a first reference angle with respect to the first boundary line BL1.

The plurality of split common electrodes CE10 provided in the first domain D1 may be arranged such that portions of plurality of split pixel electrodes PE10 are spaced a preset distance DL2 from each other.

The preset distance DL2 may be a distance between center lines CL of neighboring split common electrodes CE10 along a direction of the first boundary line BL1.

Also, a first reference slope of the center line CL of each of the plurality of split common electrodes CE10 provided in the first domain D1 may be the same as a reference slope of a reference line RL of each common slit.

First reference distances SD1 between sides adjacent to the first boundary line BL1 among sides of the plurality of split common electrodes CE10 may be the same.

Second reference distances SD2 between sides adjacent to an outer line OL among the sides of the plurality of split common electrodes CE10 may be the same.

The plurality of split common electrodes CE10 provided in the first domain D1 may be spaced from each other based on the reference lines RL having the first reference slope and a preset distance DL2.

The first reference slope of the reference lines RL may be identical to a slope of a center line of each of the plurality of split common electrodes.

A width of each of a plurality of common slits of each domain on the first boundary line BL1 of the common electrode may be greater than a width of each of the plurality of common slits of each domain on the outer line OL of the common electrode.

The width of each of the plurality of common slits of each domain may decrease toward the outer line OL from the first boundary line BL1. Therefore, a width of each of the plurality of split common electrodes may increase toward the outer line OL from the first boundary line BL1.

An arrangement of the plurality of common slits of each domain may be symmetrical to that of a plurality of common slits of another adjacent domain based on the first boundary line BL1 or the second boundary line BL2.

For example, an arrangement of a plurality of common slits of the first domain D1 may be symmetrical to that of a plurality of common slits of the second domain D2 with respect to the first boundary line BL1.

The arrangement of a plurality of common slits of the first domain D1 may be symmetrical to that of a plurality of common slits of the third domain D3 with respect to the second boundary line BL2.

The arrangement of the plurality of common slits of the second domain D2 may be symmetrical to that of a plurality of common slits of the fourth domain D4 with respect to the second boundary line BL2.

The arrangement of the plurality of common slits of the third domain D3 may be symmetrical to that of the plurality of common slits of the fourth domain D4 with respect to the first boundary line BL1.

As shown in FIG. 21, sub pixel electrodes corresponding to sub pixels may have the same configuration for each sub pixel. Accordingly, a configuration of one sub pixel electrode corresponding to one sub pixel will be described.

A sub pixel electrode of the second electrode portion 124 may be divided into a plurality of domains D1, D2, D3, and D4.

A sub pixel electrode may be divided into a sub pixel electrode of a first domain D1, a sub pixel electrode of a second domain D2, a sub pixel electrode of a third domain D3, and a sub pixel electrode of a fourth domain D4.

In each of the sub pixel electrodes of the first, second, third, and fourth domains D1, D2, D3, and D4, one or at least two pixel slits SPL may be provided.

A sub pixel electrode of each domain may be split into a plurality of split pixel electrodes by the one or at least two pixel slits PSL.

The pixel slits PSL provided in the sub pixel electrodes of the respective domains may have different slopes.

The plurality of split pixel electrodes of the respective domains may have different arrangements depending on the slopes of the pixel slits SL, and electric fields of the respective domains may be formed in different directions to correspond to the arrangements of the split pixel electrodes for the respective domains. Also, the liquid crystals may be aligned in different directions depending on the slopes of the pixel slits SL for the respective domains.

As shown in FIG. 22, the sub pixel electrode of the first domain D1 may include a plurality of split pixel electrodes PE10 arranged at a slope corresponding to a first reference slope of first pixel slits PSL10.

The sub pixel electrode of the second domain D2 may include a plurality of split pixel electrodes PE20 arranged at a slope corresponding to a second reference slope of second pixel slits PSL20.

The sub pixel electrode of the third domain D3 may include a plurality of split pixel electrodes PE30 arranged at a slope corresponding to a third reference slope of third pixel slits PSL30.

The sub pixel electrode of the fourth domain D4 may include a plurality of split pixel electrodes PE40 arranged at a slope corresponding to a fourth reference slope of fourth pixel slits PSL40.

The plurality of split pixel electrodes of the respective domains may have different slopes with respect to a center CP of the plurality of domains. That is, a plurality of split pixel electrodes of each domain may have the same or similar reference slopes.

Also, the plurality of split pixel electrodes of each domain may be arranged at the same or similar angles to correspond to the slopes.

An angle of a slope of a split pixel electrode of each domain may be an angle between a center line of the split pixel electrode and a boundary line of the domains.

The center line of the split pixel electrode may be a center line between two long sides of the split pixel electrode, which face each other, and is referred to as the center line CL.

That the angles corresponding to the slopes of the split pixel electrodes are similar to each other may include a case in which a difference between an angle corresponding to a slope of any split pixel electrode and a reference angle falls within a reference difference range.

For example, an angle an1 of a center line of each of the plurality of first split pixel electrodes PE10 arranged in the first domain D1 may be an angle between −90 degrees and 0 degrees (or an angle between 270 degrees and 0 degrees). A first reference angle for the first domain D1 may be about-45 degrees or about 315 degrees.

An angle an2 of a center line of each of the plurality of second split pixel electrodes PE20 arranged in the second domain D2 may be an angle between 0 degrees and 90 degrees. A second reference angle for the second domain D2 may be about 45 degrees.

An angle an4 of a center line of each of the plurality of fourth split pixel electrodes PE40 arranged in the fourth domain D4 may be an angle between 90 degrees and 180 degrees. A third reference angle for the fourth domain D4 may be about 135 degrees.

An angle an4 of a center line of each of the plurality of third split pixel electrodes PE30 arranged in the third domain D3 may be an angle between 180 degrees and 270 degrees (or an angle between −90 degrees and −180 degrees). A fourth reference angle for the third domain D3 may be about 225 degrees.

A reference difference range for each domain may be between −45 degrees and 45 degrees.

The plurality of split pixel electrodes provided in the first, second, third, and fourth domains D1, D2, D3, and D4 may be symmetrical to each other with respect to the first boundary line BL1 and symmetrical to each other with respect to the second boundary line BL2.

More specifically, an arrangement of the first split pixel electrodes PE10 of the first domain D1 may be symmetrical to that of the second split pixel electrodes PE20 of the second domain D2 with respect to the first boundary line BL1.

The arrangement of the first split pixel electrodes PE10 of the first domain D1 may be symmetrical to that of the third split pixel electrodes PE30 of the third domain D3 with respect to the second boundary line BL2.

An arrangement of the second split pixel electrodes PE20 of the second domain D2 may be symmetrical to that of the fourth split pixel electrodes PE40 of the fourth domain D4 with respect to the second boundary line BL2.

The arrangement of the third split pixel electrodes PE30 of the third domain D3 may be symmetrical to that of the fourth split pixel electrodes PE40 of the fourth domain D4 with respect to the first boundary line BL1.

The plurality of split pixel electrodes provided in the first, second, third, and fourth domains D1, D2, D3, and D4 may be identical to each other in shape and arrangement configuration even if the split pixel electrodes are arranged at different reference angles in the domains D1, D2, D3, and D4.

Hereinafter, the plurality of split pixel electrodes PE10 of the first domain D1 will be described as an example.

As shown in FIG. 23, each of the plurality of split pixel electrodes PE10 provided in the first domain D1 may have a polygonal shape.

Each of the plurality of split pixel electrodes PE10 provided in the first domain D1 may have a triangular shape, a quadrangular shape, or a pentagonal shape according to a shape of the first domain D1 and an arrangement of the split pixel electrodes PE10. Each of the plurality of split pixel electrodes PE10 may be aligned based on a center line CL.

The center line CL of each of the plurality of split pixel electrodes PE10 may form a first reference angle with respect to the first boundary line BL1.

The plurality of split pixel electrodes PE10 provided in the first domain D1 may be arranged such that portions of plurality of split pixel electrodes PE10 are spaced a preset distance DL2 from each other.

The preset distance DL2 may be a distance between center lines CL of neighboring split pixel electrodes PE10 along a direction of the first boundary line BL1.

Also, a first reference slope of the center line CL of each of the plurality of split pixel electrodes PE10 provided in the first domain D1 may be identical to a reference slope of a reference line of each pixel slit.

First reference distances SD1 between sides adjacent to the first boundary line BL1 among sides of the plurality of split pixel electrodes PE10 may be the same.

Second reference distances SD2 between sides adjacent to an outer line OL among the sides of the plurality of split pixel electrodes PE10 may be the same.

The plurality of split pixel electrodes PE10 provided in the first domain D1 may be spaced from each other based on the reference lines RL having the first reference slope and a preset distance DL1.

The first reference slope of the reference lines RL may be the same as a slope of the center line CL of each of the plurality of split pixel electrodes PE10.

A width of each of a plurality of pixel slits of each domain on the first boundary line BL1 of the sub pixel electrode may be greater than a width of each of the plurality of pixel slits of each domain on the outer line OL of the sub pixel electrode.

The width of each of the plurality of pixel slits of each domain may decrease toward the outer line OL from the first boundary line BL1. Therefore, a width of each of the plurality of split pixel electrodes may increase toward the outer line OL from the first boundary line BL1.

An arrangement of the plurality of pixel slits of each domain may be symmetrical to that of a plurality of pixel slits of another adjacent domain based on the first boundary line BL1 or the second boundary line BL2.

For example, an arrangement of the plurality of pixel slits PSL of the first domain D1 may be symmetrical to that of the plurality of pixel slits PSL of the second domain D2 with respect to the first boundary line BL1.

The arrangement of the plurality of pixel slits PSL of the first domain D1 may be symmetrical to that of a plurality of pixel slits PSL of the fourth domain D4 with respect to the second boundary line BL2.

The arrangement of the plurality of pixel slits PSL of the second domain D2 may be symmetrical to that of a plurality of pixel slits PSL of the fourth domain D4 with respect to the second boundary line BL2.

The arrangement of the plurality of pixel slits PSL of the third domain D3 may be symmetrical to that of the plurality of pixel slits PSL of the third domain D3 with respect to the first boundary line BL1.

Sides adjacent to the first boundary BL1 among sides of the plurality of split pixel electrodes PE10 are referred to as first sides, and sides adjacent to the outer line OL among the sides of the plurality of split pixel electrodes PE10 are referred to as second sides.

Sides adjacent to the first boundary BL1 among sides of the plurality of split common electrodes are referred to as first sides, and sides adjacent to the outer line OL among the sides of the plurality of split common electrodes are referred to as second sides.

As shown in FIG. 24, positions of the common slits provided in the respective common electrodes CE may be misaligned from those of the pixel slits provided in the sub pixel electrodes PE. That is, the positions of the common slits provided in the common electrodes CE of the first electrode portion 123 may not face those of the pixel slits provided in the sub pixel electrodes PE of the second electrode portion 124.

As shown in FIG. 25, positions of the common slits CSL adjacent to the outer line OL may correspond to center areas of the second sides of the split pixel electrodes PE10.

Positions of the common slits CSL adjacent to the first boundary line BL1 may correspond to center areas of the first sides of the split pixel electrodes PE10.

Positions of the pixel slits PSL adjacent to the outer line OL may correspond to center areas of the second sides of split common electrodes CE10.

Positions of the pixel slits CSL adjacent to the first boundary line BL1 may correspond to center areas of the first sides of the split common electrodes CE10.

As shown in FIGS. 26 and 27, the plurality of split pixel electrodes of the second electrode portion 124 may be spaced from the split common electrodes of the first electrode portion 123.

A spacing distance between the first electrode portion 123 and the second electrode portion 124 may correspond to the thickness of the liquid crystal portion 125.

When power is supplied to the first electrode portion 123 and the second electrode portion 124, an electric field may be formed between the first electrode portion 123 and the second electrode portion 124.

In an electric field, a plurality of electric field lines may be formed, which are paths along which positive charges move in a direction of an applied force.

The electric field lines may move vertically from a surface of an electrode portion at the high potential, and when the electric field lines move, the electric field lines may change a direction toward an electrode portion at the low potential and move. The plurality of electric field lines may neither split nor intersect each other while moving. Also, the electric field lines may have a characteristic of gathering at the corners of the first and second electrode portions 123 and 124.

An electric field may be formed between the plurality of split common electrodes of the first electrode portion 123 and the plurality of split pixel electrodes of the second electrode portion 124.

The electric field formed between the plurality of split common electrodes of the first electrode portion 123 and the plurality of split pixel electrodes of the second electrode portion 124 may correspond to shapes of the split common electrodes and the split pixel electrodes.

That is, electric field lines of an electric field on the first sides S1 among the sides of the plurality of split pixel electrodes may be different from electric field lines of an electrical field on the second sides S2 of the plurality of split pixel electrodes.

As shown in FIG. 26, an electric field may be formed between the first sides S1 of the split pixel electrodes PE11 and PE12 spaced the first reference distance SD1 from each other and the split common electrodes CE11 and CE12 spaced the first reference distance SD1 from each other.

In areas where the first sides S1 of the split pixel electrodes PE11 and PE12 face the first sides S1 of the split common electrodes CE11 and CE12, electric force lines each having a substantially straight shape may be formed.

At the corners of the first sides S1 of the split pixel electrodes PE11 and PE12 and the corners of the first sides S1 of the split common electrodes CE11 and CE12, electric field lines each having a substantially diagonal shape or a substantially parabolic shape may be formed.

The electric field lines formed at the corners of the first sides S1 of the split pixel electrodes PE11 and PE12 may be formed up to center positions of surfaces of the first sides S1 of the split common electrodes CE11 and CE12.

The center positions of the surfaces of the first sides S1 of the split common electrodes CE11 and CE12 may correspond to the positions of the pixel slits PSL.

The electric field lines formed at the corners of the first sides S1 of the split common electrodes CE11 and CE12 may be formed up to center positions of surfaces of the first sides S1 of the split pixel electrodes PE11 and PE12.

The center positions of the surfaces of the first sides S1 of the split pixel electrodes PE11 and PE12 may correspond to the positions of the common slits CSL.

The electric field lines formed at the corners of the first sides S1 of the split common electrodes CE11 and CE12 or the corners of the first sides S1 of the split pixel electrodes PE11 and PE12 may have lower slopes than electric field lines each having a straight shape.

The electric field lines formed at the corners of the first sides S1 of the split common electrodes CE11 and CE12 or the corners of the first sides S1 of the split pixel electrodes PE11 and PE12 may not intersect each other.

As shown in FIG. 27, an electric field may be formed between the second sides S2 of the split pixel electrodes PE11 and PE12 spaced the second reference distance SD2 from each other and the split common electrodes CE11 and CE12 spaced the second reference distance SD2 from each other.

In areas where the second sides S2 of the split pixel electrodes PE11 and PE12 face the second sides S2 of the split common electrodes CE11 and CE12, electric field lines each having a substantially straight shape may be formed.

At the corners of the second sides S2 of the split pixel electrodes PE11 and PE12 and the corners of the second sides S2 of the split common electrodes CE11 and CE12, electric field lines each having a substantially diagonal shape or a substantially parabolic shape may be formed.

The electric field lines formed at the corners of the second sides S2 of the split pixel electrodes PE11 and PE12 may be formed up to center positions of surfaces of the second sides S2 of the split common electrodes CE11 and CE12.

The center positions of the surfaces of the second sides S2 of the split common electrodes CE11 and CE12 may correspond to the positions of the pixel slits PSL.

The electric field lines formed at the corners of the second sides S2 of the split common electrodes CE11 and CE12 may be formed up to the center positions of the surfaces of the second sides D2 of the split pixel electrodes PE11 and PE12.

The center positions of the surfaces of the second sides S2 of the split pixel electrodes PE11 and PE12 may correspond to the positions of the common slits CSL.

The electric field lines formed at the corners of the second sides S2 of the split common electrodes CE11 and CE12 or the corners of the second sides S2 of the split pixel electrodes PE11 and PE12 may have lower slopes than the electric field lines each having the straight shape.

The electric field lines formed at the corners of the second sides S2 of the split common electrodes CE11 and CE12 or the corners of the second sides S2 of the split pixel electrodes PE11 and PE12 may not intersect each other.

Comparing FIG. 26 to FIG. 27, electric field lines having lower slopes may be formed around the first sides S1 of the split pixel electrodes and the first sides S1 of the split common electrodes than around the second sides S2 of the split pixel electrodes and the second sides S2 of the split common electrodes.

That is, the slopes of the electric field lines each having the diagonal shape and formed at the corners of the first sides S1 of the split common electrodes and the corners of the first sides S1 of the split pixel electrodes may be lower than the slopes of the electric field lines each having the diagonal shape and formed at the corners of the second sides S2 of the split common electrodes and the corners of the second sides S2 of the split pixel electrodes.

A minimum one of the slopes of the electric field lines each having the diagonal shape and formed at the corners of the first sides S1 of the split common electrodes and the corners of the first sides S1 of the split pixel electrodes may be lower than a minimum one of the slopes of the electric field lines each having the diagonal shape and formed at the corners of the second sides S2 of the split common electrodes and the corners of the second sides S2 of the split pixel electrodes.

Because a distance between the second sides S2 of the split pixel electrodes is smaller than a distance between the first sides S1 of the split pixel electrodes, a spacing between electric field lines formed between the first sides S1 of the split pixel electrodes may be greater than a spacing between electric field lines between the second sides S2 of the split pixel electrodes.

Accordingly, because slopes of electric field lines of an electric field change depending on a change in distance between the split pixel electrodes and a change in distance between the split common electrodes, alignment angles of the liquid crystals may be adjusted.

When an electric field is formed, the liquid crystals of the liquid crystal portion 125 may be aligned based on electric field lines. That is, when no electric field is formed, the liquid crystals of the liquid crystal portion 125 may be aligned vertically between the first electrode portion 123 and the second electrode portion 124, and when an electric field is formed, the liquid crystals of the liquid crystal portion 125 may be aligned horizontally between the first electrode portion 123 and the second electrode portion 124 to correspond to electric field lines.

As shown in FIG. 28, when an electric field is formed between the first electrode portion 123 and the second electrode portion 124, light may be emitted through an area corresponding to the pixel electrodes PE10 of the second electrode portion 124 among the areas of the sub pixels. Also, dark parts may be formed in areas corresponding to the pixel slits PSL of the second electrode portion 124 among the areas of the sub pixels, and dark parts may be formed in areas corresponding to the common slits CSL of the first electrode portion 123 among the areas of the sub pixels.

As shown in FIG. 29, the liquid crystals of the liquid crystal portion 125 may be aligned horizontally in areas where the flat areas of the first sides S1 of the split pixel electrodes of the second electrode portion 124 face the flat areas of the first sides S1 of the split common electrodes, among the areas of the liquid crystal portion 125.

The liquid crystals of the liquid crystal portion 125 may be aligned substantially horizontally (or parallel) to electric field lines at the center areas and corner areas of the first sides S1 of the split pixel electrodes of the second electrode portion 124 to correspond to the direction in which the electric field lines are formed, among the areas of the liquid crystal portion 125. That is, the liquid crystals of the liquid crystal portion 125 may be aligned substantially vertically at the center areas and corner areas of the first sides S1 of the split pixel electrodes of the second electrode portion 124, among the areas of the liquid crystal portion 124.

An alignment angle of the liquid crystals corresponding to the flat areas of the first sides S1 of the split pixel electrodes of the second electrode portion 123 facing the flat areas of the first sides S1 of the split common electrodes may be different from an alignment direction of the liquid crystals corresponding to the center areas of the first sides S1 of the split pixel electrodes.

The alignment angle of the liquid crystals at the flat areas of the first sides S1 of the split pixel electrodes of the second electrode portion 123 facing the flat areas of the first sides S1 of the split common electrodes may be different from an alignment direction of the liquid crystals at the corner areas of the first sides S1 of the split pixel electrodes.

As shown in FIG. 30, the liquid crystals of the liquid crystal portion 125 may be aligned horizontally at areas corresponding to the flat areas of the second sides S2 of the split pixel electrodes of the second electrode portion 124 facing the flat areas of the second sides S2 of the split common electrodes, among the areas of the liquid crystal portion 125.

The liquid crystals of the liquid crystal portion 125 may be aligned substantially horizontally (or parallel) to electric field lines at the center areas and corner areas of the second sides S2 of the split pixel electrodes of the second electrode portion 124 to correspond to the direction in which the electric field lines are formed, among the areas of the liquid crystal portion 125. The liquid crystals of the liquid crystal portion 125 may be aligned substantially vertically at the center areas and corner areas of the second sides S2 of the split pixel electrodes of the second electrode portion 124, among the areas of the liquid crystal portion 125.

An alignment angle of the liquid crystals at the flat areas of the second sides S2 of the split pixel electrodes of the second electrode portion 124 facing the flat areas of the second sides S2 of the split common electrodes may be different from an alignment angle of the liquid crystals at the center areas of the second sides S2 of the split pixel electrodes.

The alignment angle of the liquid crystals at the flat areas of the second sides S2 of the split pixel electrodes of the second electrode portion 124 facing the flat areas of the second sides S2 of the split common electrodes may be different from an alignment angle of the liquid crystals at the corner areas of the second sides S2 of the split pixel electrodes.

A width of each of split common electrodes forming a common electrode in one domain may increase toward the outer line OL from the first boundary line BL1 of the domains.

A spacing distance between split pixel electrodes forming a pixel electrode in one domain may decrease toward the outer line OL from the first boundary line BL1 of the domains. That is, a spacing distance between a fourth side of any split pixel electrode and a third side of a neighboring split pixel electrode may decrease toward the outer line OL from the first boundary line BL1 of the domains.

Also, a width of each of split common electrodes forming a common electrode in one domain may increase toward the outer line OL from the first boundary line BL1 of the domains.

A spacing distance between split common electrodes forming a common electrode in one domain may decrease toward the outer line OL from the first boundary line BL1 of the domains. That is, a spacing distance between a fourth side of any split common electrode and a third side of a neighboring split common electrode may decrease toward the outer line OL from the first boundary line BL1 of the domains.

Accordingly, when an electric field is formed between the first electrode portion 123 and the second electrode portion 124, the liquid crystals may be aligned with different angles at corners of third and fourth sides of split pixel electrodes forming a pixel electrode.

A line X1-X2 in FIG. 28 may be a split line based on a first reference angle of a center line CL of a split pixel electrode and a position of the split pixel electrode.

The first reference angle may be an angle at which the liquid crystals have maximum transmittance.

The first reference angle may be an angle that forms substantially 45 degrees with respect to the polarization axis of the second polarizing panel 120c.

As shown in FIG. 31, a width of each split pixel electrode with respect to the center line CL may increase toward the outer line OL from the first boundary line BL1.

A width of each split common electrode with respect to the center line CL may increase toward the outer line OL from the first boundary line BL1.

As an area of each split common electrode increases toward the outer line OL from the first boundary line BL1 and an area of each split pixel electrode increases toward the outer line OL from the first boundary line BL1, a strength of an electric field formed between the sub pixel electrode and the common electrode may increase toward the outer line OL from the first boundary line BL1.

That is, an area of the plurality of split pixel electrodes facing the plurality of split common electrodes may increase toward the outer line of the sub pixel electrode from the center line of the sub pixel electrode. Accordingly, a strength of an electric field formed between the plurality of split pixel electrodes and the plurality of split common electrodes may increase toward the outer line of the sub pixel electrode from the center line of the sub pixel electrode. An alignment angle of the liquid crystals may change depending on the strength of the electric field.

Therefore, different alignment angles of the liquid crystals may appear around the split common electrodes and the split pixel electrodes.

An alignment angle of the liquid crystals around the first sides S1 of the split common electrodes and the split pixel electrodes may be smaller than that of the liquid crystals around the second sides S2 of the split common electrodes and the split pixel electrodes.

Here, an alignment angle of liquid crystals may be set based on an alignment angle of liquid crystals aligned vertically. That is, an angle of liquid crystals aligned vertically may be 0 degrees.

According to one or more embodiments, because a width of each split pixel electrode increases toward the outer line OL from the first boundary line BL1 of the domains based on the reference slope of the pixel slits provided in the sub pixel electrode or the first reference angle of the center line CL of the split pixel electrode, an alignment angle of the liquid crystals on the third side of the split pixel electrode may increase toward the outer line OL from the first boundary line BL1.

So far, the disclosed embodiments have been described with reference to the accompanying drawings. It will be understood by one of ordinary skill in the technical art to which the disclosure belongs that the disclosure can be embodied in different forms from the disclosed embodiments without changing the technical spirit and essential features of the present disclosure. Thus, it should be understood that the disclosed embodiments described above are merely for illustrative purposes and not for limitation purposes in all aspects.

What is claimed is:

1. A display device comprising:
a common electrode;
a split pixel electrode spaced from the common electrode and divided into a plurality of domains; and
a liquid crystal portion provided between the common electrode and a sub pixel electrode,
wherein the sub pixel electrode comprises, in each domain of the plurality of domains, at least one pixel slit of which a width on a center line of the sub pixel electrode is greater than a width on an outer line of the sub pixel electrode, and
wherein adjacent domains of the plurality of domains have symmetrical arrangements of the at least one pixel slit.

2. The display device of claim 1, wherein, in each domain, the sub pixel electrode is divided into a plurality of split pixel electrodes by the at least one pixel slit, and
wherein the adjacent domains of the plurality of domains have symmetrical arrangements of the plurality of split pixel electrodes.

3. The display device of claim 2, wherein, in each domain, a width of a first side of each of the plurality of split pixel electrodes, the first side being adjacent to the center line of the sub pixel electrode, is smaller than a width of a second side of each of the plurality of split pixel electrodes, the second side being adjacent to the outer line of the split pixel electrode.

4. The display device of claim 3, wherein, in each domain, a reference slope of the at least one pixel slit is the same as a slope of a center line of each of the plurality of split pixel electrodes, and
wherein the center line of each of the plurality of split pixel electrodes is a line connecting a center of the first side of the split pixel electrode to a center of the second side of the split pixel electrode.

5. The display device of claim 4, wherein the reference slope of the at least one pixel slit is a slope of a center line of the at least one pixel slit,
wherein the center line of the at least one pixel slit is a line connecting a center of a width of the at least one pixel slit on the center line of the sub pixel electrode to a center of a width of the at least one pixel slit on the outer line of the sub pixel electrode, and
wherein each of the plurality of split pixel electrodes is spaced a preset distance from a position of the center line of the at least one pixel slit.

6. The display device of claim 3, wherein first distances between first sides of the plurality of split pixel electrodes are the same,
wherein second distances between second sides of the plurality of split pixel electrodes are the same, and
wherein the first distances are greater than the second distances.

7. The display device of claim 3, wherein, in each domain, a strength of an electric field formed between the plurality of split pixel electrodes and the common electrode increases toward the second side of each split pixel electrode from the first side of the split pixel electrode.

8. The display device of claim 1, wherein the common electrode is divided into the plurality of domains, and, in each domain, the common electrode comprises at least one common slit of which a width on a center line of the common electrode is greater than a width on an outer line of the common electrode, and
wherein the adjacent domains of the plurality of domains have symmetrical arrangements of the at least one common slit.

9. The display device of claim 8, wherein, in each domain, the common electrode is divided into a plurality of split common electrodes by the at least one common slit,
wherein the adjacent domains of the plurality of domains have symmetrical arrangements of the plurality of split common electrodes, and
wherein in each domain, a width of a first side of each of the plurality of split common electrodes, the first side being adjacent to the center line of the common electrode, is smaller than a width of a second side of each of the plurality of split common electrodes, the second side being adjacent to the outer line of the common electrode.

10. The display device of claim 8, wherein the common electrode is divided into a plurality of split common electrodes by the at least one common slit,
wherein, in each domain, a reference slope of the at least one common slit is the same as a slope of a center line of each of the plurality of split common electrodes, and
wherein the center line of each of the plurality of split common electrodes is a line connecting a center of the first side of a split common electrode to a center of the second side of the split common electrode.

11. The display device of claim 8, wherein the common electrode is divided into a plurality of split common electrodes by the at least one common slit,
wherein a reference slope of the at least one common slit is a slope of a center line of the at least one common slit,
wherein the center line of the at least one common slit is a line connecting a center of a width of the at least one common slit on the center line of the common electrode to a center of a width of the at least one common slit on the outer line of the common electrode, and
wherein the plurality of split common electrodes are spaced a preset distance from a position of the center line of the at least one common slit.

12. The display device of claim 10, wherein first distances between first sides of the plurality of split common electrodes are the same,
wherein second distances between second sides of the plurality of split common electrodes are the same, and
wherein the first distances are greater than the second distances.

13. The display device of claim 8, wherein the sub pixel electrode is divided into a plurality of split pixel electrodes by the at least one pixel slit, and the common electrode is divided into a plurality of split common electrodes by the at least one common slit,
wherein a position of the at least one common slit corresponds to a surface area of at least one split pixel electrode among the plurality of split pixel electrodes, and
wherein a position of the at least one pixel slit corresponds to a surface area of at least one split common electrode among the plurality of split common electrodes.

14. The display device of claim 8, wherein the sub pixel electrode is divided into a plurality of split pixel electrodes by the at least one pixel slit, and the common electrode is divided into a plurality of split common electrodes by the at least one common slit,
wherein a distance between the plurality of split common electrodes decreases toward the outer line of the common electrode from the center line of the common electrode, and
wherein a distance between the plurality of split pixel electrodes decreases toward the outer line of the sub pixel electrode from the center line of the sub pixel electrode.

15. The display device of claim 14, wherein an area of the plurality of split pixel electrodes facing the plurality of split common electrodes increases toward the outer line of the sub pixel electrode from the center line of the sub pixel electrode, and
wherein a strength of an electric field formed between the plurality of split pixel electrodes and the plurality of split common electrodes increases toward the outer line of the sub pixel electrode from the center line of the sub pixel electrode.
